(19) United States
(12) Patent Application Publication
(10) Pub. No.: US 2024/0250809 A1
(43) Pub. Date: Jul. 25, 2024

(54) MULTI-PARTY COMPUTATION FOR MANY COMPUTERS

(71) Applicant: VISA INTERNATIONAL SERVICE ASSOCIATION, SAN FRANKCISCO, CA (US)

(72) Inventors: Saikrishna Badrinarayanan, Fremont, CA (US); Peter Rindal, San Francisco, CA (US); Peihan Miao, Chicago, IL (US)

(73) Assignee: VISA INTERNATIONAL SERVICE ASSOCIATION, SAN FRANKCISCO, CA (US)

(21) Appl. No.: 18/560,248

(22) PCT Filed: May 25, 2022
(86) PCT No.: PCT/US2022/030896

§ 371 Date: Nov. 10, 2023

Related U.S. Application Data
(60) Provisional application No. 63/192,933, filed on May 25, 2021.

(51) Int. Cl. H04L 9/08; H04L 9/32

(52) U.S. Cl. CPC H04L 9/085; H04L 9/3242

(57) ABSTRACT

Embodiments of the present disclosure are directed to methods for multi-party fixed point multiplication. The methods can include replicated methods for multi-party fixed point multiplication where the inputs and output are represented using replicated secret sharing. One replication method can require only a single round of communication in the online phase and is secure against a semi-honest adversary. Another replication method can require may include an additional key to identify any malicious communicating parties. The methods can also include a Shamir sharing fixed point multiplication method and an additive secret sharing fixed point multiplication method.

### CROSS-REFERENCES TO RELATED APPLICATIONS

This application claims the benefit of U.S. Provisional Application No. 63/192,933, filed May 25, 2021, which is herein incorporated by reference in its entirety for all purposes.

### BACKGROUND

Machine learning models can be used for a wide range of applications. In many instances, to train and evaluate machine learning models, large volumes of data may be obtained from various data sources. However, in many instances, portions of received data can include sensitive or private information.

Computers (e.g., servers) performing secret share of data can use a multi-party computation technique to train and evaluate machine learning models using the jointly-obtained data. The multi-party computation technique can allow for retrieval of the data for evaluating and training of the machine learning models without requiring the dissemination of any sensitive/private information across the nodes.

### SUMMARY

One embodiment of the present disclosure is directed to a method performed by a first computer of a plurality of computer for implementing a replication protocol for multi-party fixed point multiplication. The first computer can obtain a first secret share of a first fixed value (x) and a second secret share of a second fixed value (y). The first computer can then jointly sample a first pseudo-random key (s_{i,j}) with another computer paired with the first computer and a second pseudo-random key (sⱼ) with a first set (Dⱼ) of multiple sets in the plurality of computers. The first computer can generate a replicated random share of a random value ( [symbol] r [symbol] ^{R}) using the second pseudo-random key (sⱼ) and then generate a replicated sharing value (β) using the first pseudo-random key (s_{i,j}). The first computer can compute a masked share (z′ᵢ) by providing a product of the first secret share and the second secret share masked with the replicated sharing value (β) and the replicated random shares of the random value ( [symbol] r [symbol] ^{R}). The first computer can receive, from computers in the first set (Dⱼ), a plurality of masked shares (z′ᵢ), thereby revealing a set shared value z′ to the first set (Dⱼ). The first computer can then generate a replicated secret share ( [symbol] z [symbol] ^{R}) using the received plurality of masked shares (z′ᵢ) and the replicated random shares of the random value ( [symbol] r [symbol] ^{R}).

Another embodiment of the present disclosure is directed to a method performed by a first computer of a plurality of computers for implementing a sharing protocol for multi-party fixed point multiplication. The first computer can obtain a secret share of a first value (x), a secret share of a second value (y). The first computer can then sample a first random value (rᵢ) to obtain a first random share ( [symbol] rᵢ [symbol] ^{S,2t}) of the first random value (rᵢ) and a second random share ( [symbol] rᵢ/d [symbol] ^{S}). The first computer can send the first random share ( [symbol] rᵢ [symbol] ^{S,2t}) and the second random share [symbol] rᵢ/d [symbol] s to the plurality of computers. The first computer can also obtain each share of the first random share ( [symbol] r [symbol] ^{S,2t}) and each share of the second random share [symbol] rᵢ/d [symbol] s from the plurality of computers. The first computer can then compute a third random share ( [symbol] r [symbol] ^{S,2t}) and a fourth random share ( [symbol] r′ [symbol] ^{S}) based on each share of the first random share ( [symbol] r [symbol] ^{S,2t}) and each share of the second random share [symbol] rᵢ/d [symbol] s, respectively. The first computer can compute a masked share ( [symbol] z′ [symbol] ^{S,2t}) that provides a product of the secret share of the first value (x) and the secret share of the second value (y) masked with the third random share ( [symbol] r [symbol] ^{S,2t}). The first computer can then obtain a masked value z′ based on a plurality of masked shares ( [symbol] z′ [symbol] ^{S,2t}) determined by the plurality of computers and then generate an output secret share ( [symbol] z [symbol] ^{S}) using the masked value z′ and the fourth random share ( [symbol] r′ [symbol] ^{S}).

Another embodiment of the present disclosure is directed to a method performed by a first computer of a plurality of computers for implementing an additive sharing protocol for multi-party fixed point multiplication. The first computer can obtain a secret share ( [symbol] ^{A}) of a first value (x), a secret share ( [symbol] ^{A}) of a second value (y), a decimal bit value (d), a secret share ( [symbol] α [symbol] ^{A}) of a third value (α), a secret share ( [symbol] β [symbol] ^{A}) of a fourth value (β), and a secret share ( [symbol] γ [symbol] ^{A}) of a fifth value (γ). The first computer can determine determining a share of a first shared random value ( [symbol] r′ [symbol] ^{A}) and a share of a second shared random value ( [symbol] r [symbol] ^{A}). The first computer can determine a first intermediate share ( [symbol] ^{A}) based on the secret share ( [symbol] ^{A}) of the first value (x) and the secret share ( [symbol] α [symbol] ^{A}) of the third value (α) and then determine a second intermediate share ( [symbol] ^{A}) based on the secret share ( [symbol] ^{A}) of the second value (y) and the secret share ( [symbol] β [symbol] ^{A}) of the fourth value (β). The first computer can receive a plurality of first intermediate shares and a plurality of second intermediate shares from the plurality of computers to reveal a first intermediate value (x′) and a second intermediate value (y′). The first computer can send the first intermediate value (x′) and the second intermediate value (y′) to the plurality of computers. The first computer can then determine a third intermediate share ( [symbol] z′ [symbol] ^{A}) based on the first intermediate value (x′), the second intermediate value (y′), the secret share ( [symbol] ^{A}) of the first value (x), the secret share ( [symbol] y [symbol] ^{A}) of the second value (y), the secret share ( [symbol] y [symbol] ^{A}) of the fifth value (γ) and the share of the second shared random value ( [symbol] r [symbol] ^{A}). The first computer can receive a plurality of third intermediate shares from the plurality of computers to reveal a third intermediate value (z′). The first computer can send the third intermediate value (z′) to the plurality of computers. The first computer can then determine determining an output secret share ( [symbol] ^{A}) based on the third intermediate value (z′), the decimal bit value (d), and the share of the first shared random value ( [symbol] r′ [symbol] ^{A}).

These and other embodiments of the disclosure are described in detail below. For example, other embodiments are directed to systems, devices, and computer readable media associated with methods described herein.

A better understanding of the nature and advantages of embodiments of the present disclosure may be gained with reference to the following detailed description and the accompanying drawings.

Reference to the remaining portions of the specification, including the drawings and claims, will realize other features and advantages of the present disclosure. Further features and advantages of the present disclosure, as well as the structure and operation of various embodiments of the present disclosure, are described in detail below with respect to the accompanying drawings. In the drawings, like reference numbers can indicate identical or functionally similar elements.

### BRIEF DESCRIPTION OF THE DRAWINGS

FIG. 1 shows a multiparty fixed point multiplication system according to an embodiment of the present disclosure.

FIG. 2 shows a computer system comprising sets of computers according to an embodiment of the present disclosure.

FIG. 3 is an example signaling process for a replication protocol for multi-party fixed point multiplication in a semi-honest setting according to an embodiment of the present disclosure.

FIG. 4 is a block diagram illustrating an example replication protocol for multi-party fixed point multiplication in a malicious setting according to an embodiment of the present disclosure.

FIG. 5 is a block diagram of an example Shamir sharing protocol for multi-party fixed point multiplication according to an embodiment of the present disclosure.

FIG. 6 is a block diagram of an example additive sharing protocol for multi-party fixed point multiplication according to an embodiment of the present disclosure.

FIG. 7 shows a block diagram of an example computer system usable with systems and methods according to embodiments of the present disclosure.

### TERMS

Prior to discussing embodiments of the invention, description of some terms may be helpful in understanding embodiments of the invention.

The term “server computer” may include a powerful computer or cluster of computers. For example, the server computer can be a large mainframe, a minicomputer cluster, or a group of computers functioning as a unit. In one example, the server computer may be a database server coupled to a web server. The server computer may be coupled to a database and may include any hardware, software, other logic, or combination of the preceding for servicing the requests from one or more other computers. The term “computer system” may generally refer to a system including one or more server computers, which may be coupled to one or more databases.

A “machine learning model” can refer to a set of software routines and parameters that can predict an output(s) of a real-world process (e.g., a diagnosis or treatment of a patient, identification of an attacker of a computer network, authentication of a computer, a suitable recommendation based on a user search query, etc.) based on a set of input features. A structure of the software routines (e.g., number of subroutines and relation between them) and/or the values of the parameters can be determined in a training process, which can use actual results of the real-world process that is being modeled.

The term “training computer” can refer to any computer that is used in training the machine learning model. As examples, a training computer can be one of a set of client computers from which the input data is obtained, or a server computer that is separate from the client computers.

“Multi-party computation” (MPC) may refer to a computation that is performed by multiple parties. Each party, such as a computer, server, or cryptographic device, may have some inputs to the computation. Each party can collectively calculate the output of the computation using the inputs.

“Secure multi-party computation” (secure MPC) may refer to a multi-party computation that is secure. In some cases, “secure multi-party computation” refers to a multi-party computation in which the parties do not share information or other inputs with each other. Determining a PSI can be accomplished using a secure MPC. The inputs from each computer in an MPC may be secret shares of a value that is known to one computer. For example, a first computer can split a database value into multiple secret shares and distribute the shares among the computers. Only the first computer may know how to assemble the shares to reconstruct the database value. One way to generate the shares is by selecting a random number and then taking an XOR of the random number and a value of an individual database table, which can be done independently for each value in a database.

The term “secret-sharing” can refer to any one of various techniques that can be used to store a data item on a set of training computers such that each training computer cannot determine the value of the data item on its own. As examples, the secret-sharing can involve splitting a data item up into shares that require a sufficient number (e.g., all) of training computers to reconstruct and/or encryption mechanisms where decryption requires collusion among the training computers.

The term “secret” can include a value not known or seen or not meant to be known or seen by others. A secret can be a value that is intended to remain only known by a computer, entity, group, etc. A secret can be shared securely in an obfuscated type manner using a secret-sharing technique to create a plurality of secret shares.

The term “secret share” can include portion of a value not known or seen or not meant to be known or seen by others. A secret share, in isolation, may not reveal information regarding the secret. A secret share can be created using a secret sharing technique. The combination of all, or a portion of all, of the secret shares can reveal the secret.

The term “set” an refer to a group of things. A set of computers can be a group of computers within an overall network of computers. A network of computers can include any number of sets of computers. In some cases, a computer can belong (e.g., be a part of) to one or more sets of computers.

The term “set shared value” can include a value held by entities in a set. A set shared value can be a value that is known by each computer in a set of computers, but not by computers in a computer network that are not in the set of computers.

### DETAILED DESCRIPTION

Machine learning is used to produce models that classify images, perform medical diagnosis, provide recommendations, and identify fraudulent transactions among several other applications. Cloud-based machine learning services [1-4] can perform both training models using user data as well as performing inference on pre-trained models. The data being classified or used for training is often sensitive and may come from multiple sources with different privacy requirements. Thus, privacy preserving machine learning, which aims to perform both training and inference while maintaining the privacy of user's data, has become increasingly important.

Secure multi-party communication (MPC) can be used for transmitting data for training and/or evaluating machine learning models while retaining privacy of the data. Secure MPC can ensure that, during training, the only information leaked about the data may be the final model (or an encrypted version of the model). Further, during evaluation, the only information leaked can include the output label. One setting considered is where data owners (e.g., clients) secret share their data among multiple independent servers that perform training on the combined data or apply a (secret shared) pre-trained model to evaluate new data samples. There have been several solutions proposed in literature [6, 17, 20, 30, 32, 34-39, 41, 44]. However, most of them focus on the setting of two or three servers where an adversary can corrupt at most one of them. In a context where multiple parties are interacting (e.g., greater than three parties), there is a gap between plaintext training/evaluation and privacy-preserving solutions for secure MPC.

The present embodiments can provide multiple forms of secret sharing to represent input to be multiplied and the output. For example, embodiments provide for a replicated secret sharing protocol, a Shamir secret sharing protocol, and an additive secret sharing protocol. The protocols as described herein can relate to a scenario where there are more than three parties and a number of the parties are honest (e.g., can be trusted to implement a protocol for secure MPC).

In the case of many machine learning algorithms, both training data and the intermediate parameters may include decimal values that cannot be natively handled using modular arithmetic. Many approaches may fail when performing floating point multiplications, and a large modulus can imply can imply a more complex multiplication that can reduce performance. Embodiments described herein can provide efficient multi-party fixed point multiplication where the inputs and outputs are secret amongst interacting parties. Embodiments provide a technical solution to, at least, the technical problem of how to efficiently perform multi-party fixed point multiplication methods where the inputs and outputs are secret shared amongst a plurality of computers.

Further, the protocols as described herein can include efficient multi-party fixed point multiplication protocols where one or more parties can include covert adversaries that may not follow the protocol. In such instances, embodiments can detect malicious behavior by the covert adversarial parties by invocating the multiplication protocols as described herein.

### I. SECURE MULTI-PARTY COMMUNICATION AND SECRET SHARING OVERVIEW

Embodiments provide for a method for truncating secret shared values, for example, by computing [symbol] := [symbol] /2^{d} where d is a public value that denotes a number of decimal bits in a fixed-point value. The aforementioned truncation method can then be combined with multiplication protocol(s) to obtain a fixed-point multiplication protocol(s). Embodiments provide for three forms of secret sharing to represent the inputs to be multiplied and the output: replicated, Shamir, and additive secret sharing. However, it is understood that embodiments can apply to various other secret sharing schemes.

### A. Replicated Secret Sharing

The present embodiments provide multiple replicated protocols for multi-party fixed point multiplication where the inputs and output are represented using replicated secret sharing over modulus 2^{k}, where k is the bit length of the shares.

The first protocol is secure against a semi-honest adversary in the presence of an honest majority and does not utilize offline communication prior to the protocol. The protocol has two forms according to embodiments: 1) a single round protocol utilizing (n²−nt)k bits of online communication and 2) two rounds utilizing only 2nk bits of online communication, where n is the number of computers (also referred to as parties) and t<n/2 is the number of corrupt computers. The communication overhead of such methods is significantly better than the previous work of Mohassel and Rindal [36] for multi-party fixed point multiplication in the same setting. The communication cost is compared in Table 1, below.

The second protocol can require two rounds in the online phase and can be secure in the presence of a covert adversary (e.g., a party that can behave arbitrarily maliciously).

### B. Shamir Secret Sharing

Embodiments provide for an efficient multi-party fixed point multiplication protocol where the inputs and output are represented using Shamir secret sharing. The protocol utilizes two rounds in the online phase and is secure against a semi-honest adversary in the presence of an honest majority. Compared to the prior work of Catrina and Saxena [16] for the same setting, according to embodiments the online communication overhead is the same while offline communication is significantly lower since n, t«k typically in practice (see Table 1).

### C. Additive Secret Sharing

The aforementioned approaches for replicated and Shamir secret sharing can occur in a setting where an honest majority is present among the computers. This is inherently required by these secret sharing schemes.

However, it is understood that it is not a requirement of the truncation method according to embodiments. In fact, the truncation protocol can be viewed as a technique that works for even for dishonest majority. This can be demonstrated by utilizing the truncation method to create an efficient multi-party fixed point multiplication protocol where the inputs and output are represented using an n-out-of-n additive secret sharing scheme. Such a method can be a four-round protocol, which is secure against a semi-honest adversary that can corrupt any t<n parties.

### D. Performance and General MPC

The communication and computation cost of the three aforementioned protocols is close to a standard secret shared modular multiplication. For replicated secret sharing the protocol is as computationally complex as the modular counter-part. The same holds for Shamir for a dishonest majority.

TABLE 1
Communication (in bits) and round complexity of embodiments
compared to [16, 36]. n is the number of parties, t <
n/2 is the number of corrupt parties. 2^{k} is the modulus for replicated
secret sharing. k = └log₂(q)┘ where q
is the prime modulus is for Shamir secret sharing.

| | Online | | |
|---|---|---|---|
| Protocol | Rounds | Online Comm | Offline Comm |
| Replicated (Embodiments) | 1 or 2 | (n² − nt)k or | 0 |
| | | 2nk | |
| Replicated ([36]) | 1 | (n² − nt)k | (n² − nt)tk |
| Shamir (Embodiments) | 2 | 2nk | (n − t − 1)(t + 1)k |
| Shamir ([16]) | 2 | 2nk | 2k²n. |

For each form of secret sharing, embodiments can leverage the fixed-point multiplication protocol to design an MPC protocol for computing arbitrary arithmetic circuits that contain addition and fixed-point multiplication with truncation gates. It can then be proved that the resulting MPC protocol is secure via a standard real world-ideal world simulation based security definition.

### II. PRELIMINARIES

Prior to describing further details of secret sharing methods, a notational base will be described that can aid in the understanding and description of embodiments.

### A. Notation

A computational security parameter can be referred to using x and a statistical security parameter can be referred to using λ. The parties (also referred to as nodes or computers) are enumerated as P₁, . . . , Pₙ, where there are a total of n parties. The notation [symbol] denotes a secret sharing of a value x. This sharing can be one of several different types— [symbol] ^{R}, [symbol] ^{S} or [symbol] ^{A} as described in further detail below. Regardless of the sharing type, the notation of [symbol] ᵢ will refer to the share of the value x held by the party i, denoted as Pᵢ.

The assignation of a variable can be denoted by :=, for example a variable a can be assigned to the value of b by a:=b. When uniformly sampling from a set S or sampling a randomized function ƒ, embodiments use the notation a←S and a←ƒ( . . . ) respectively. Let [a, b] denote the set {a, a+1, . . . , b} and the shorthand [b]:=[1, b]. A parentheses on the left or right side denotes that corresponding side of the range is exclusive, such as (a, b]: {a+1, a+2, . . . , b}. Discussion of the definitions of pseudorandom functions (PRFs), which are used as one of the cryptographic primitives utilized in the constructions herein, can be found in [27].

### B. Computation Representations

In secure computation, functions can be represented as a circuit where each wire can hold an integer value modulo some public modulus N∈ [symbol] such as N=2 for Booleans and N=2^{k} or a prime q for arithmetic operations. According to embodiments, arithmetic circuits can be considered with N=2^{k} or a prime q. In the case of a prime modulus q, k:=└ log₂(q)┘ can be defined such that 2^{k} is just smaller than q. In addition to being able to perform these types of modular arithmetics, this framework supports both signed and fixed-point arithmetics such that fractional numbers can efficiently be represented.

For signed values, a value x∈[−N/2, N/2) can be represented as \hat{x}:=(x mod N). For N=2^{k}, this is also known as two's complement, where the highest order bit indicates sign (e.g., positive or negative). The same approach also works when N is a prime. Sometimes it can be more convenient to consider a signed value as simply an element of [symbol] _{N} (integer numbers set), while at other times x∈[−N/2, N/2) is more natural. In particular, embodiments can use the notation [symbol] _{N}:=[−N/2, N/2) to denote this range. Regardless, performing addition, subtraction, and multiplication in [symbol] _{N} or [symbol] _{N} has a one-to-one correspondence. The symmetric mod operator x′:=(x symod N) can be defined as the unique value x′∈ [symbol] _{N} such that (x mod N)=(x′ mod N).

Fixed-point values have support for representing rational numbers [symbol] , such as x=1.25. This can be achieved by having the bottom d bits of an integer represent the fractional part. That is, let xᵢ∈ [symbol] ₂ be the i′th bit of an unsigned x, then x=Σ2^{i-d}xᵢ. A set of fixed point values can be parameterized by two integers N, d. The set of (signed) values can then be described as Fx_{N,d}:={x/2^{d} x∈ [symbol] _{N}} where the division is performed over [symbol] and it is assumed that N>2^{d}. Addition and subtraction can be defined in the natural/standard way. For multiplication of x, y∈Fx_{N,d}, the result can be defined as xy∈ [symbol] rounded down to the next multiple of 2^{-d}.

### C. Security Model

Consider a ring of values [symbol] _{N} and a value k′ where 2^{k}′»N. Consider any arithmetic circuit C_{d} with addition and fixed-point multiplication with truncation gates. The multiplication gates are associated with a truncation parameter d and an error distribution ε. Given two input values x and y, the output of the gate is (xy/2^{d}+e) where e is a rounding error term sampled from the distribution ε. Each party Pᵢ has an input inpᵢ∈ [symbol] ₂_{^{k′}} and their goal may be to evaluate the circuit C_{d} on these n joint inputs without revealing any information about their respective inputs. The input values satisfy the property that when evaluating circuit C_{d}, the inputs and output of any multiplication gate lies in [symbol] ₂_{^{k′}}.

Embodiments can follow the standard real-ideal world simulation based security definition for secure multiparty computation (MPC) [27]. The ideal functionality [symbol] _{C}_{_{d}} is defined in Table 2, below. Various embodiments consider an adversary that corrupts at most t of the parties and study both semi-honest and malicious adversaries.

TABLE 2
Ideal functionality for computing an arithmetic circuit C_{d} over a ring [symbol] _{N}. [symbol]
_{C}_{_{d}}

```
Parameters: An arithmetic circuit C_{d} that contains addition and fixed-point multiplication with
truncation gates, where the multiplication gates have a error distribution ε.
Input: Each party Pᵢ provides input inpᵢ.
Computation: Compute out = C_{d}(inp₁, ... , inpₙ) where each fixed-point multiplication gate
with input x and y is processed as follows:
  1. Let e ← ε be the rounding error term sampled from the distribution ε.
  2. Let the multiplication output be xy/2^{d} + e.
Output: Send the output out to every party.
```

### D. Computer System

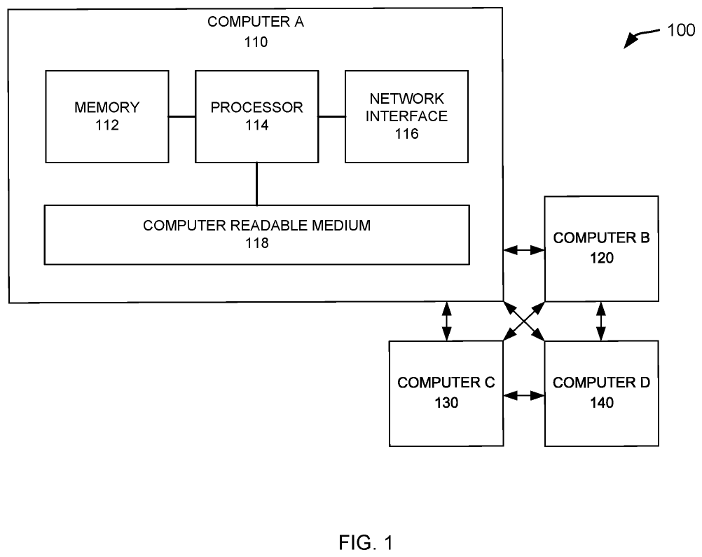

FIG. 1 shows a system 100 according to embodiments of the disclosure. The system 100 comprises a plurality of computers including a computer A 110, a computer B 120, a computer C 130, and a computer D 140. Each computer of the plurality of computers can be in operative communication with any other computer in the system 100.

The computer A 110 includes a memory 112, a processor 114, a network interface 116, and a computer readable medium 118. The processor 114 can be coupled to the memory 112, the network interface 116, and the computer readable medium 118.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. For example, even though the components of computer A 110 are illustrated in FIG. 1, it is understood that the computer B 120, the computer C 130, and/or the computer D 140 can have similar components.

Messages between the computers in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The memory 112 of the computer A 110 can be used to store data and code. For example, the memory 112 can store secret shared values. The memory 112 may be coupled to the processor 114 internally or externally (e.g., cloud based data storage), and may comprise any combination of volatile and/or non-volatile memory, such as RAM, DRAM, ROM, flash, or any other suitable memory device.

The network interface 116 may include an interface that can allow the computer A 110 to communicate with external computers. The network interface 116 may enable the computer A 110 to communicate data to and from another device (e.g., to other computers in the system 100, etc.). Some examples of the network interface 116 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 116 may include Wi-Fi™. Data transferred via the network interface 116 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 116 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The computer readable medium 118 may comprise code, executable by the processor 114, for performing methods according to embodiments described herein. As an illustrative example, the computer readable medium 118 can comprise code, executable by the processor 114 for performing a method performed by a first computer of a plurality of computer for implementing a replication protocol for multi-party fixed point multiplication, the method comprising: obtaining a first secret share of a first fixed value (x) and a second secret share of a second fixed value (γ); jointly sampling a first pseudo-random key (s_{i,j}) with another computer paired with the first computer and a second pseudo-random key (sⱼ) with a first set (Dⱼ) of multiple sets in the plurality of computers; generating a replicated random share of a random value ( [symbol] r [symbol] ^{R}) using the second pseudo-random key (sⱼ); generating a replicated sharing value (β) using the first pseudo-random key (s_{i,j}); computing a masked share (z′ᵢ) by providing a product of the first secret share and the second secret share masked with the replicated sharing value (β) and the replicated random shares of the random value ( [symbol] r [symbol] ^{R}); receiving, by the first computer from computers in the first set (Dⱼ), a plurality of masked shares (z′ᵢ), thereby revealing a set shared value z′ to the first set (Dⱼ); and generating a replicated secret share ( [symbol] z [symbol] ^{R}) using the received plurality of masked shares (z′ᵢ) and the replicated random shares of the random value ( [symbol] r [symbol] R).

### III. SECRET SHARING TECHNIQUES

Embodiments provide for several techniques for performing fixed-point computation. A first method includes efficient replicated secret sharing over the ring [symbol] ₂_{^{k}}, which is an improvement over the secret sharing methods as performed by [36, 37]. A second approach is for secret sharing over a prime field [symbol] _{q} such as Shamir secret sharing. A third approach is for additive secret sharing. Embodiments consider different types of secret sharing schemes depending on the number of computers and the setting: replicated secret sharing [symbol] ^{R} for a small number of computers, and Shamir and additive secret sharing [symbol] ^{S} for a larger number of computers.

Regardless of whether the sharing scheme naturally supports [symbol] ₂_{^{k}} (e.g., as in replicated secret sharing) or [symbol] _{q} (e.g., as in Shamir secret sharing), the operations according to embodiments follow a similar approach. For example, for a computer Pᵢ to input a value x∈Fx_{N,d}, the computer Pᵢ maps a value x into a target group and secret shares the value x. Specifically, for a replicated secret sharing system including [symbol] ₂_{^{k}} and N=2^{k}, the computer Pᵢ can compute x′:=x2^{d} mod 2^{k} and then run an input sharing protocol. In the case of Shamir secret sharing over [symbol] _{q}, the computer Pᵢ can compute x′:=x2^{d} modq and can input x′. Addition and subtraction of shared values and multiplication by a public integer follow the same approach as the standard secret sharing. To reveal a shared fixed-point value [symbol] to some of the parties, first the standard reveal procedure is performed to reveal x′. The final result is then computed as x:=x′/2^{d}∈Fx_{N,d}.

A technical problem that is present in multiplying this style of fixed-point secret shares is that the standard protocol would result in a semantic value in Fx_{N,2d} given input values in Fx_{N,d} and also ignores the possibility of the product overflowing N. That is, let [symbol] , [symbol] be sharing of values x, y∈Fx_{N,d} as described above. Then, when computing [symbol] := [symbol] (e.g., multiplying the values) using the standard [symbol] ₂_{^{k}} (e.g., replicated secret sharing) or [symbol] _{q} (e.g., Shamir secret sharing) protocols would result in a value z′ such that z′/2^{d}≈xy where the approximation comes from the rounding of the lower order terms. Truncation can then be used to take a shared value in Fx_{N,2d} and produce shares of that value rounded into Fx_{N,d}.

Ideally, this rounding would exactly correspond to multiplication in Fx_{N,d} (rounding down to the nearest 2^{-d}), but several works [16, 36, 37] have shown that a significant performance improvement can be achieved by allowing probabilistic rounding. Embodiments capture this probabilistic rounding in an ideal functionality [symbol] ₘᵤₗ^{N,d,ε} which is parameterized by a modulus N, the number of decimal bits d, and a rounding error distribution ε. This distribution can specify how the rounding can be performed.

Embodiments adapt and improve these prior approaches beyond the two party setting while reducing the communication overhead.

TABLE 3
Probabilistic functionality for fixed-point multiplication. [symbol]
ₘᵤₗ^{N,d,ε}

```
Fixed-point Multiply: The functionality is parameterized by a modulus N ∈ [symbol]  , a number of
decimal bits d ∈ [symbol]  , and a rounding error distribution ε. Upon receiving shares [symbol]  , [symbol]  from
parties, the funtionality reconstructs x, y ∈ Fx_{N,d}.
  1. Sample e ← ε as the rounding error term.
  2. Output [symbol]  xy/2^{d} + e [symbol]   to the respective parties.
```

### A. Replicated Secret Sharing

A value x∈ [symbol] is replicated secret shared by uniformly sampling x₁, . . . , xₘ∈ [symbol] for

$$m := ( \begin{matrix}n \\ n - t\end{matrix} )$$

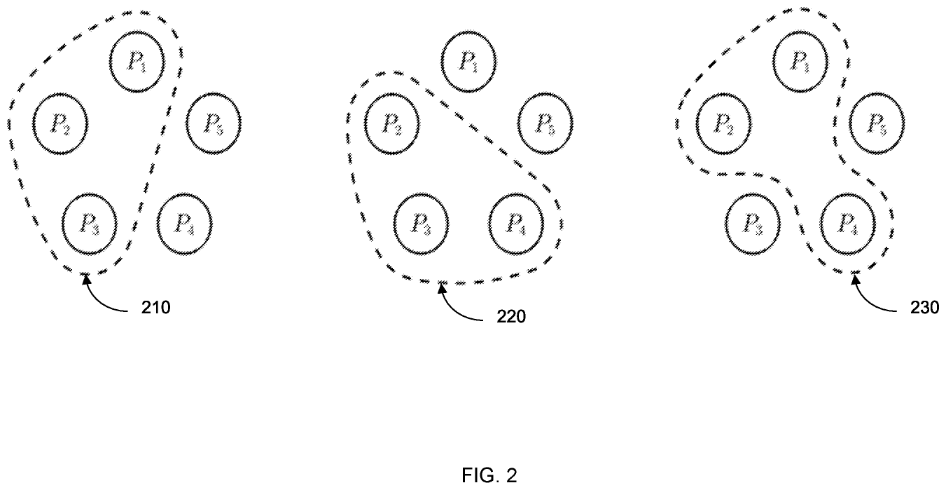

such that x=Σᵢxᵢ. [symbol] can be any group such as [symbol] ₂_{^{k}}, [symbol] ₂_{^{k}} or [symbol] _{q} for a prime q. To obtain a t-out-of-n replicated secret sharing of the value x, it is possible to distribute these shares such that every subset of (t+1) parties holds all m shares of the value x, yet any smaller grouping of parties is missing at least one share. One method for doing this is as follows. Define the sets D₁, . . . , Dₘ⊂[n] as the m distinct subsets of size (n−t). Without loss of generality, for i∈[n], let D₁={i, i+1, i+2, . . . } be the contiguous set of computer indices starting at index i, with wrap around, as illustrated in respect to FIG. 2. The replicated secret share of the i^{th} computer Pᵢ is then [symbol] ᵢ^{R}:={xⱼ|i∈Dⱼ}. Embodiments can use the group [symbol] ₂_{^{k}}.

FIG. 2 illustrates a computer system comprising sets of computers according to an embodiment of the present disclosure. FIG. 2 illustrates three different sets of computers grouped from the same network of computers. FIG. 2 includes a first set of computers 210 (D₁), a second set of computers 220 (D₂), and a third set of computers 230 (D₃). The network of computers can comprise any number of computers grouped into any number of overlapping sets of computers.

The first set of computers 210 includes a first computer P₁, a second computer P₂, and a third computer P₃. The second set of computers 220 includes the second computer P₂, the third computer P₃, and a fourth computer P₄. The third set of computers 230 includes the first computer P₁, and the fourth computer P₄. In replicated secret sharing, a share xᵢ can be held (e.g., stored) by all of the computers indexed by Dᵢ.

Due to the linearity of the method, addition, subtraction, or multiplication with a public constant can be performed locally by applying the corresponding operation to the shares. For example, computing [symbol] := [symbol] ^{R}+ [symbol] ^{R} can be done by having each computer Pᵢ define the output shares [symbol] ⱼ^{R}:= [symbol] ⱼ^{R}+ [symbol] ⱼ^{R}. Subtraction works in the same way while public multiplication [symbol] ^{R}:=c [symbol] ^{R} can be perform by defining [symbol] ⱼ^{R}:=c [symbol] ⱼ^{R}. To multiply two secret shared values [symbol] ^{R}:= [symbol] ^{R} [symbol] ^{R}, parties can perform an interactive protocol due to cross terms between the values of x and y. Multiplication of two secret shared values is described in more detail herein.

The replicated secret sharing methods according to embodiments can be utilized for a 2-out-of-2 secret sharing scheme over a ring [symbol] ₂_{^{k}}. A value zε [symbol] ₂_{^{k}}, is secret shared into two random values z₁, z₂∈ [symbol] ₂_{^{k}} such that z₁+z₂=z and for some k≥k′. Mohassel and Zhang [37] showed that so long as |z|«2^{k}, then with high probability where the division is the quotient over the integers. Here, the possibility of having a minus one comes from the fact that if (z₁ mod 2^{d})+(z₂ mod 2^{d})≥2^{d}, then this would have generated a “carry bit” which was eliminated by performing separate division operations on the shares, mathematically shown below.

$$\frac{{z}_{1}}{{2}^{d}} + \frac{{z}_{2}}{{2}^{d}} ∈ \{ \frac{z}{{2}^{d}} , \frac{z}{{2}^{d}} - 1 \}$$

There are two subtleties in understanding this approach: 1) the individual shares z₁, z₂ should be interpreted as being signed integers in the range [symbol] ₂_{^{k}}=[−2^{k-1}2^{k-1}) and 2) the necessity for |z|«2^{k-1}. In the event that z₁+z₂ wraps around in the ring [symbol] ₂_{^{k}} (e.g., if when interpreting [symbol] ₁, [symbol] ₂ as integers and adding them results in ( [symbol] ₁+ [symbol] ₂)>2^{k-1} or ( [symbol] ₁+ [symbol] ₂)>2^{k-1}+1), then it must hold that the values z₁, z₂ are both positive or negative and that the value z has the opposite sign. However, after dividing z₁, z₂ by 2^{d}, the addition of these values can no longer wrap around [symbol] ₂_{^{k}} and as such does not sum to z/2^{d}. This event where z₁+z₂ wraps around is referred to as a catastrophic error [37].

To fix these catastrophic errors, [37] observed the following. First, redefine the shares by a random value

$$r {←}^{\$} {𝕊}_{{2}^{k}}$$

and z₁:=−r, z₂:=r+z and require z∈ [symbol] ₂_{^{k′}} where 2^{k′}«2^{k}. Then, with probability at least 1-2^{k′-k} it holds that the values z₁ and z₂ do not have the same sign since this would imply that r+z wraps around [symbol] ₂_{^{k}} and the top k-k′ bits of r are set to 1. Given that z₁, z₂ do not have the same sign it is impossible for them to wrap around 5₂_{^{k}} and therefore 2^{d}/z₁+2^{d}/z₂ will be equal to 2^{d}/z or 2^{d}/z−1 as described above.

Unfortunately, this approach does not generalize to more than two parties. A reason is that it is likely for the shares to wrap around the modulus, regardless of the distribution of the value x. Mohassel and Rindal [36] were able to circumvent this issue by emulating the two party protocol in the multi-party setting. This required the addition of a preprocessing phase where a truncation pair [symbol] ^{R}, [symbol] r/2^{d} [symbol] ^{R} is computed. Given this the protocol above can be emulated by revealing [symbol] ^{R}:= [symbol] ^{R}− [symbol] ^{R} and then letting [symbol] z₂/2^{d} [symbol] ^{R}:= [symbol] r/2^{d} [symbol] ^{R}. Since z₁ is made public, all parties can compute [symbol] z/2^{d} [symbol] := [symbol] z/2^{d} [symbol] ^{R}+z₁/2^{d}.

The main limitation of [36] is the nee to generate the truncation pair [symbol] ^{R}, [symbol] r/2^{d} [symbol] ^{R}. [36] present a three-party preprocessing protocol which requires 2 k binary AND gates in the semi-honest setting and 4 k in the malicious setting. Generalizing this approach results in 2tk and 2mk AND gates respectively in the multi-party scenario. Since the overhead of this approach does not scale as n grows.

$$m = ( \begin{matrix}n \\ t\end{matrix} ) = O ( {2}^{n} ) ,$$

Embodiments solve the aforementioned technical problems, which stem from the original “carry bit” technical problem discussed above. Embodiments provide for an efficient technique for generating a multi-party sharing of a value x which is guaranteed not to wrap around the modulus. As a starting point, consider secret sharing x∈ [symbol] ₂_{^{k}}, over [symbol] ₂_{^{k}} (where k≥k′+λ+log₂m) by sampling each share x₂, . . . ,

$${x}_{m} {←}^{\$} {𝕊}_{{2}^{{k}^{′} + λ}}$$

and then defining the last share as x₁=x−x₂− . . . −xₘ. Observe that random shares are sampled over a 2^{λ} times larger range as compared to the underlying value, where λ is the statistical security parameter. This is utilized in order to sufficiently hide the value of x.

By definition, this type of sharing cannot wrap around the modulus and as such, locally dividing each share approximately truncates the underlying secret shared value. In particular:

$$x = {x}_{1} + … + {x}_{m} = {2}^{d} ( \frac{{x}_{1}}{{2}^{d}} + … + \frac{{x}_{m}}{{2}^{d}} ) + ( {x}_{1} symod {2}^{d} + … + {x}_{m} symod {2}^{d} )$$

$$x / {2}^{d} - e = \frac{{x}_{1}}{{2}^{d}} + … + \frac{{x}_{m}}{{2}^{d}}$$

where e:=(x₁ symod 2^{d}+ . . . +xₘ symod 2^{d})/2^{d}∈[−m, m]. That is, locally dividing the shares results in the secret shared value being similarly truncated with an absolute error |e| of at most logm bits.

This approach does not, in isolation, provide a practical secret sharing scheme due to the size of the shares doubling after each multiplication. Embodiments overcome this value size problem by effectively converting a traditional secret sharing (e.g., replicated) into the sharing described above, performing the division and then converting back.

The efficient replicated secret sharing technique will now be discussed. First let us consider the task of dividing a replicated secret sharing [symbol] ^{R} of a value x by 2^{d} to obtain a sharing [symbol] ^{R} where z≈x/2^{d} over the integers. Combining this with the multiplication protocol with little added overhead, will be described in further detail herein.

Recall that each replicated secret sharing consists of m shares, distributed among n parties, in particular, x=(x₁+ . . . +xₘ) symod 2^{k}. Embodiments can utilize a secret value in a ring x∈ [symbol] ₂_{^{k}}, for some 2^{k′}«2^{k} (e.g., k=k′+λ+log₂m).

The parties jointly sample a random sharing [symbol] ^{R} of a random value r, where share rᵢ is defined as rᵢ← [symbol] ₂_{^{k′+λ}}. This type of secret sharing has three noteworthy properties. A first property is that [symbol] ^{R} does not wrap around [symbol] ₂_{^{k}} when reconstructed (e.g., r=(r₁+ . . . +rₘ)=(r₁+ . . . +rₘ symod 2^{k})). A second property is that the distributions of the random value r and the sum of the random value r and the secret value x (e.g., w:=r+x) are statistically close. This second property follows from the random value r being distributed over a range that is approximately 2^{λ+log}₂^{m} times bigger than the secret value x. A third property is that the random sharing [symbol] ^{R} can be sampled non-interactively by sampling the shares as the output of a pseudorandom function (PRF).

The protocol can proceed by revealing a revealed value ω, which is equal to [symbol] ^{R}:= [symbol] ^{R}+ [symbol] ^{R}, to all parties. Assume that r+x does not wrap around and observe that:

$$w = x + r$$

$$w / {2}^{d} = \frac{x + r}{{2}^{d}}$$

$$w / {2}^{d} = ( \frac{x}{{2}^{d}} + \frac{{r}_{1}}{{2}^{d}} + … + \frac{{r}_{m}}{{2}^{d}} ) + e ,$$

$$where e := ( x symod {2}^{d} + {r}_{1} symod {2}^{d} + … + {r}_{m} symod {2}^{d} ) / {2}^{d}$$

$$x / {2}^{d} + e = \frac{w}{{2}^{d}} - \frac{{r}_{1}}{{2}^{d}} - … - \frac{{r}_{m}}{{2}^{d}}$$

As before, the error value e∈[−m, m]. The parties can locally compute shares of [symbol] ^{R}= [symbol] x/d²+e [symbol] ^{R} given the revealed value [symbol] and a shared random value [symbol] ^{R} by defining z₁:= [symbol] /2^{d}−rᵢ/2^{d} and zᵢ:=−rᵢ/2^{d} for i∈[2, m].

Next, fused multiplication and truncation will be described. The trivial way of performing a fused multiply and truncate method is to first perform the standard multiplication protocol to compute [symbol] z′ [symbol] ^{R}:= [symbol] x [symbol] ^{R} [symbol] y [symbol] ^{R} and then the truncation protocol to compute [symbol] z [symbol] ^{R}: [symbol] z′ [symbol] ^{R}/2^{d}. The main downside of this approach is the need to perform two rounds of interaction.

First, recall the normal multiplication protocol. Observe that the multiplied secret values [symbol] =(x₁+ . . . +xₘ)(y₁+ . . . +yₘ)=Σ_{j,j}, xⱼyⱼ, and that the shares are distributed such that at least one computer can compute each cross term xⱼy_{j′}. The shares xⱼ, yⱼ will be held by computer Pᵢ for all i∈Dⱼ (the set of parties Dⱼ consists of a set of (n−t) parties and by definition, Pᵢ∈Dᵢ). Each cross term xⱼyⱼ, can be assigned to a single Pᵢ and let uᵢ be the sum of the crossterms. For j∈(n, m], the parties in the set of parties Dⱼ non-interactively sample z′ⱼ← [symbol] ₂_{^{k}}. In addition, the parties non-interactively sample an n-out-of-n zero-sharing [symbol] s [symbol] where a computer Pᵢ holds a zero-sharing share sᵢ and the sum of all zero-sharing shares equals zero Σᵢsᵢ=0. Given these, the computer Pᵢ defines z′ᵢ:=uᵢ+sᵢ−Σ_{j∈N}_{ᵢ} z′ⱼ and distributes z′ᵢ to all parties in the set of parties Dᵢ. Here Nᵢ⊂(n, m] index the set of z′ⱼ terms that are assigned to the computer Pᵢ. A detailed description of this protocol is given in Table 7.

There are two sets of randomized shares, 1) z′ⱼ for j∈(n, m] and 2) rᵢ for i∈[n], which play slightly different roles. Given that the adversary corrupts t parties, there will be exactly one index j*∈[m] for which they do not hold the share (e.g., y_{j*}). As such, z′_{j*} should be sampled uniformly, as is done above.

The zero sharing [symbol] s [symbol] serves a slightly different purpose. For exposition, let's assume a first secret value x is somehow known to the adversary while a second secret value y, and therefore yⱼ*, is not. The honest parties Pᵢ will each use yⱼ* to compute their share z′ᵢ, when determining the product of the first secret value x and the second secret value y. As such, if sᵢ was not included, for some of these z′ᵢ values, the adversary will know all the other terms and can solve for yⱼ*. However, by including the zero sharing, embodiments effectively “distribute” the uncertainty the adversary has about z′_{j*} into all of the z′ᵢ messages that are sent.

Now, the multiplication and division protocols can be combined into a single fused operation. A change is that instead of distributing shares of z′, the parties will directly reveal w=z′+r and then perform the division step as described before. Beyond this conceptual change, it can be observed that sampling the z′ⱼ shares for j∈(n, m] are no longer necessary due to z′ being sufficiently masked by the random value r.

In more detail, each computer Pᵢ computes the sum uᵢ of their cross terms xⱼ, yⱼ, along with their zero sharing sᵢ. The sharing of the random value [symbol] ^{R} is sampled as

$${r}_{i} {←}^{\$} {𝕊}_{{2}^{{k}^{′} + λ}}$$

which ensures that the random value r will not wrap around. The computer Pᵢ computes wt:=uᵢ+sᵢ+Σ_{j∈N}_{ᵢ} rⱼ and reveal it to all parties. The final output shares are defined as z₁:=w₁/2^{d}−r₁/2^{d} and zᵢ=−rᵢ/2^{d} for i∈[2, m]. A detailed description of the semi-honest secure protocol is given in Table 6.

To achieve malicious security, embodiments can include an information theoretic MAC αz′ along with the term z′. The MAC key α is unknown to the adversary and is secret shared amongst all the parties. Using [symbol] ^{R}, parties can computes secret shares of αz′. Then, a MAC check protocol (e.g., as an example, from in FIG. 10 of [23]) can be run that checks that shares of the MAC term αz′ are consistent with [symbol] ^{R} and z′. From this, it can be guaranteed that the term z′ was correctly computed by the adversary. Finally, after computing [symbol] ^{R} as in the semi-honest protocol, embodiments can also compute the MAC [symbol] ^{R}. Table 9, below, describes the method in further detail.

### B. Shamir Secret Sharing

To Shamir secret share [43] a value x∈ [symbol] , a computer that holds a value x can sample a uniformly random polynomial pₓ(·)∈ [symbol] [⋅] of degree t such that a first point of the polynomial lies at the value x (e.g., pₓ(0)=x). Each computer [symbol] is given a point [symbol] ᵢ^{S}:=pₓ( [symbol] ), which is the evaluation of the polynomial pₓ at a point [symbol] . A degree t polynomial is uniquely defined by (t+1) points, so it follows that any subset of (t+1) parties can use their shares to reconstruct the polynomial pₓ and retrieve the secret value x=pₓ(0), while any subset of fewer than (t+1) parties learn no information about the secret. The notation [symbol] ^{S,t′} can denote the Shamir secret sharing of the value x using a polynomial of degree t′. Typically, embodiments will be described in reference to polynomials of degree t and omit the degree in this case for brevity (e.g., [symbol] ^{S}) and consider [symbol] = [symbol] _{q} for a prime q, however it is understood that embodiments are not limited thereto.

As in the case of replicated secret sharing, observe that addition and multiplication b a constant can be performed locally on each share. That is to compute [symbol] ^{S}:= [symbol] ^{S}+c or [symbol] ^{S}:=c [symbol] ^{S}, each computer Pᵢ locally compute [symbol] := [symbol] +c or [symbol] :=c [symbol] , respectively. Similarly, to calculate the sum of two shared values [symbol] ^{S}:= [symbol] ^{S}+ [symbol] ^{S}, each computer [symbol] can locally compute their shares as [symbol] := [symbol] + [symbol] ᵢ^{S}. However, additional processing is needed when multiplying two shared values and is described in further detail herein.

For the sake of comparison a detailed description of the protocol of Catrina and Saxena [16] for computing [symbol] ^{S}:≈ [symbol] ^{S}/2^{d} will be first discussed in reference to Table 4. The core of the approach is to observe that integer division by 2^{d} and modular division in [symbol] _{q} are the same when the numerator is divisible by 2^{d}. The intuition is then, given an arbitrary numerator a∈ [symbol] _{q}, embodiments compute a/2^{d} in the integers by computing (a−(a mod 2^{d}))·2^{-d} in [symbol] _{q}. The challenge is to support signed values and to give an efficient way to compute a sharing of [symbol] a mod 2^{d} [symbol] ^{S} given [symbol] a [symbol] ^{S}.

```
TABLE 4
Protocol for truncation [16, Protocol 3.1].
Π_{trunc}
Parties have access to functionality [symbol]    _{rand2}^{q,d}, which distributes shares [symbol]    r [symbol]   ^{S}, [symbol]    r′ [symbol]   ^{S} where r ϵ [symbol]    _{q}
and r′ = r mod 2^{d}.
Truncate: Upon input [symbol]    a [symbol]   ^{S}, parties do the following:
  (a) Compute [symbol]    b [symbol]   ^{S} = [symbol]    a [symbol]   ^{S} + 2^{k-1}.
  (b) Invoke [symbol]    _{rand2}^{q,d}, and receive shares [symbol]    r [symbol]   ^{S}, [symbol]    r′ [symbol]   ^{S} where r′ = r mod 2^{d}.
  (c) Send [symbol]    c [symbol]   ^{S} = [symbol]    b [symbol]   ^{S} + [symbol]    r [symbol]   ^{S} to party P₁. P₁ reconstructs c and broadcasts to other
  parties.
  (d) Compute [symbol]    a′ [symbol]   ^{S} = c′ − [symbol]    r′ [symbol]   ^{S} where c′ = c mod 2^{d}.
  (e) Compute [symbol]    d [symbol]   ^{S} = ( [symbol]   a [symbol]   ^{S} − [symbol]    a′ [symbol]   ^{S}) · 2^{-d} and take [symbol]    d [symbol]   ^{S} as output.
```

To support signed values, they require that a is in [symbol] ₂_{^{k}}=[−2^{k-1}2^{k-1}) where 2^{k}<q. They then shift a into the range [0, 2^{k}) by computing b:=a+2^{k-1} ∈ [symbol] _{q}. Now observe that a′:=b mod 2^{d} is precisely the “semantic” low order bits of a. Effectively, shifting a allows for the handling the positive and negative cases simultaneously.

Given [symbol] b [symbol] ^{S}= [symbol] a+2^{k-1} [symbol] ^{S} the parties approximate [symbol] b mod 2^{d} [symbol] ^{S} using a mask and open technique. First, the pair [symbol] r [symbol] ^{S}, [symbol] r′ [symbol] ^{S} are preprocessed where

$$r {←}^{\$} {𝔽}_{q}$$

and r′:=(r mod 2^{d}). The masked value c:=b+r is then revealed to all parties. It is required that b+r does not wrap around [symbol] _{q}, which will be discussed later. The parties define c′:=c mod 2^{d}=b+r mod 2^{d}. Observe that [symbol] a′ [symbol] ^{S}:=c′− [symbol] r′ [symbol] ^{S}=(b+r mod 2^{d})− [symbol] r′ [symbol] ^{S} is equal to (b mod 2^{d}) or (b−1 mod 2^{d}). This −1 term is due to the possibility of b+r generating a carry bit at bit position d which is eliminated by the mod 2^{d} operation. As such, this truncation will result in the same rounding error as in [36, 37]. The final result can then be computed as [symbol] d [symbol] ^{S}:=( [symbol] a [symbol] ^{S}− [symbol] a′ [symbol] ^{S})·2^{-d} which equals a/2^{d} or a/2^{d}−1 over the integers.

In [16], the multiplication and division are given separately. A follow up work [12] gave an optimization which combined the multiplication and division into a single round as shown in Table 5. At a high level, the protocol begins with the standard strategy of computing the higher degree product and opening a masked version of it. Then, following the truncation protocol of [16], the masked value z′ is shifted to the range [0, 2^{k}) and shares of the unmasked bottom d-bits are computed. These shares are then used to compute a sharing of the product that can have the bottom d-bits truncated.

```
TABLE 5
Protocol for multiplication for Shamir secret sharing.
Π_{mul-trunc} ( [symbol]   x [symbol]   ^{S}, [symbol]    y [symbol]   ^{S})
Parties hold preprocessed shares [symbol]    r [symbol]   ^{S,t}, [symbol]    r [symbol]   ^{S,2t}, [symbol]    r' [symbol]   ^{S,t}, where r is random and r′ = r mod2^{d}.
Multiple and truncate: On inputs [symbol]    x [symbol]   ^{S}, [symbol] y [symbol] ^{S}, each party does the following:
  1. Compute [symbol]    z′ [symbol]   ^{S,2t} = [symbol]    x [symbol]   ^{S}, [symbol]    y [symbol]   ^{S} + r^{S,2t}
  2. Send [symbol]    z′ [symbol]   ^{S,2t} to P₁, who reconstructs z′ and broadcasts the result to the other parties.
  3. Compute w = (z′ + 2k⁻¹) mod 2^{d} and [symbol]    w′ [symbol]   ^{S,t} = w − [symbol]    r′ [symbol]   ^{S,t}.
  4. Output [symbol]    z [symbol]   ^{S,t} = (z′ − [symbol]    r [symbol]   ^{S,t} [symbol]  w′ [symbol]   ^{S,t} ) · 2^{-d}
```

The Shamir secret sharing method according to embodiments is conceptually similar to the replicated secret sharing method. This generality speaks to the versatility of the methods according to embodiments in that it can be applied to many settings.

A first step is for the parties to sample a linear secret sharing of a random value r, which does not wrap around the modulus. One method for achieving this is to have the computer Pᵢ for i∈[t+1] sample

$${r}_{i} {←}^{\$} {𝕊}_{q / ( t + 1 )}$$

and generate a sharing of [symbol] r [symbol] ^{S} and [symbol] rⁱ/2^{d} [symbol] ^{S}. Given these, the parties can define [symbol] r [symbol] S:=Σᵢ [symbol] rᵢ [symbol] ^{S} and [symbol] r′ [symbol] ^{S,}:=Σᵢ [symbol] r₁/2^{d} [symbol] ^{S}. By the same analysis as above, r/2^{d}=r′+e for some error value e with at most log₂t bits.

Then, to truncate an existing sharing [symbol] x [symbol] ^{S} of a secret value x by 2^{d} the parties reveal [symbol] w [symbol] ^{S}:= [symbol] x [symbol] ^{S}+ [symbol] r [symbol] ^{S} to all parties. The output shares are defined as [symbol] z [symbol] ^{S}:=w/2^{d}− [symbol] r′ [symbol] ^{S}. Since the random value r is not uniformly distributed over [symbol] _{q}, this protocol requires that |x|↔q in order to argue that the secret value x remains hidden, which is a common property to all efficient division protocols. The detailed protocol is presented in Table 13.

### C. Additive Secret Sharing

A value x∈ [symbol] can be additive secret shared by uniformly sampling x₁, . . . , xₙ∈ [symbol] such that x=Σᵢxᵢ. The additive secret share of the i^{th} computer Pᵢ is then [symbol] :=xᵢ. Observe that unless all the n parties come together, no information about the secret x is learnt. Embodiments can use the group [symbol] ₂_{^{k}}. Similar to the other two sharing techniques, addition, subtraction, or multiplication with a public constant can be performed locally by applying the corresponding operation to the shares, but multiplication between two secret shared values needs additional processing.

The aforementioned approaches for replicated and Shamir secret sharing utilize a setting in which an honest majority is present among the parties. This is inherently required by these secret sharing schemes. Nevertheless, it is not a requirement of the efficient sharing and truncation technique according to embodiments. In fact, the truncation methods according to embodiments can be viewed as general techniques that works for any t<n.

For example, in the additive secret sharing setting, to truncate a secret shared value [symbol] ∈ [symbol] S_{N} where x∈ [symbol] ₂_{^{k′}} and log₂N≥k′+λ+log₂n, first let the parties sample a linear secret sharing of a random value r which does not wrap round [symbol] _{N}. In particular, each computer Pᵢ for i∈[t+1] samples

$${r}_{i} {←}^{\$} {𝕊}_{{2}^{{k}^{′} + λ}}$$

and generates sharings of [symbol] rᵢ [symbol] and [symbol] rᵢ/2^{d} [symbol] in [symbol] _{N}. Given these, the parties can define [symbol] r [symbol] :=Σᵢ [symbol] rᵢ [symbol] and [symbol] r′ [symbol] :=Σᵢ [symbol] rᵢ/2^{d} [symbol] . By the same analysis as above, embodiments have that r/2^{d}=r′+e for some error value e with at most log₂t bits.

To illustrate this idea, embodiments show how to incorporate the truncation protocol into additive secret sharing with dishonest majority and present the fixed point multiplication protocol in Table 15.

### IV. REPLICATED SECRET SHARING PROTOCOLS FOR MULTI-PARTY FIXED POINT MULTIPLICATION

Embodiments provide for a new technique for fixed point multiplication with replicated secret sharing in the presence of a semi-honest adversary. It is then shown how to incorporate this method into a general MPC protocol to compute any arithmetic circuit.

Additionally, embodiments provide for a method of performing fixed point multiplication with replicated secret sharing in the presence of a malicious adversary.

### A. Replicated Secret Sharing: Semi-Honest

For a semi-honest protocol for fixed point multiplication with replicated secret sharing, consider two fixed point values, a first secret value x and a second secret value y, represented in twos-complement form in a ring [symbol] ₂_{^{k}}, where the bottom d bits denote the decimal. The two fixed point value x and y can be secret values that are not known in the clear to any computer in the system. The computers in the system (e.g., the parties) hold replicated secret shares [symbol] and [symbol] ^{R} of the first secret value x and the second secret value y, respectively, in an extended ring [symbol] ₂_{^{k}} where k≥(k′+λ+log₂(m)).

The computers in the system can attempt to compute a replicated secret share [symbol] z [symbol] ^{R} where the output value

$$z \approx \frac{xy}{{2}^{d}} .$$

The output value z can be the product of the first secret value x and the second secret value y. The method can take place among n computers P₁, . . . , Pₙ over an extended ring [symbol] ₂_{^{k}}. The system of computers can include a plurality of sets of computers, where each set can include more than one computer. A number of distinct sets can be denoted by m and can relate to the total number of computers n by

$$m := ( \begin{matrix}n \\ n - t\end{matrix} ) {D}_{1} , … , {D}_{m} ⊂ [ n ] .$$

The method is described formally in Table 6.

In a setup phase, every pair of computers Pᵢ and Pⱼ in the system can jointly sample a first pseudo-random key s_{i,j}, while the computers in each set Dⱼ sample a second pseudo-random key sⱼ. Then, in an online phase, for each fixed point multiplication, each of the plurality of computers can jointly generate replicated shares of a random value r by locally generating each share rⱼ at random using the PRF key sⱼ. Observe that while the inputs x and y lie in [symbol] ₂_{^{k′}}, each share rᵢ lies in [symbol] ₂_{^{k′+λ}} and the random value r lies in [symbol] ₂_{^{k′+λ+log}}₂^{(m)}. The parties then use the second pseudo-random keys s_{i,j} to generate a replicated sharing of zero—represented by the β's where each βᵢ lies in [symbol] ₂_{^{k}}.

Each computer then generates a masked share z′ based on the computer's first secret value share, second secret value share, and random value share. The masked share z′ can be determined using z′=x·y+r, which can be further masked with the share of zero. The masked share z′ can be revealed to all computers in the first set of computers D₁. Note that the sharing of zero ensures that no individual share of the masked share z′ is revealed in the clear to any computer—this is because each individual share is not over the whole ring [symbol] ₂_{^{k}} and hence might leak information about the terms in the product of the first secret value x and the second secret value y if revealed in the clear.

Now, when the computers in the first set D₁ obtain the masked share z′=x·y+r, observe that although the random value r is not entirely uniform in the ring [symbol] ₂_{^{k}}, its sampling space is sufficiently larger than the value of the product of the first secret value x and the second secret value y and it is in fact statistically close to a uniform distribution, hence the masked share z′ looks sufficiently random to all the computers. Finally, each computer can obtain a replicated secret share of the sharing of [symbol] z [symbol] ^{R} by determining the first share z₁=z′/d−r₁/d and the rest of the shares as zⱼ=−rⱼ/d.

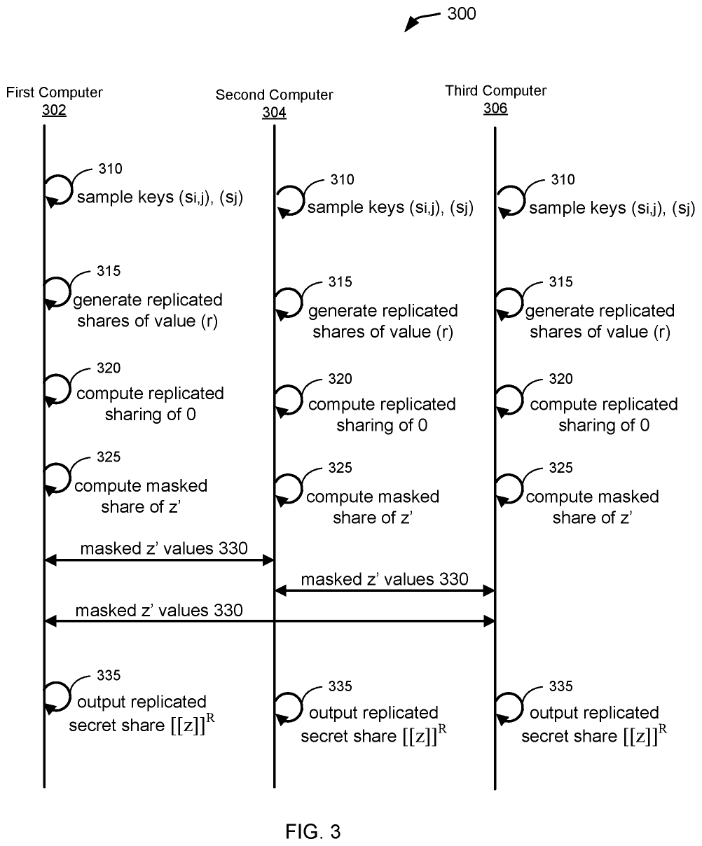

FIG. 3 illustrates an example signaling process 300 for a replication protocol for multi-party fixed point multiplication. FIG. 3 illustrates the signaling process of a replication protocol as described in Table 6. As shown in FIG. 3, a network includes a plurality of computers including a first computer 302, a second computer 304, and a third computer 306. The computers can perform a replication method for multi-party fixed point multiplication. Although three computers are illustrated in FIG. 3, it is understood that any number of computers can interact using the methods(s) as described herein.

Prior to step 310 each computer of the plurality of computers can obtain a first secret share ( [symbol] ^{R}) of a first value (x) and a second secret share ( [symbol] y [symbol] ^{R}) of a second value (y).

At step 310, each computer in the network of computers, including the first computer 302, the second computer 304, and the third computer 306, can locally sample keys (s_{i,j}, sⱼ). For example, each computer can sample a first pseudo-random key (s_{i,j}) and a second pseudo-random key (sⱼ).

The first pseudo-random key (s_{i,j}) can be generated by a pair of computers. Each computer in the network of computers can be paired with another computer in the network. The two computers in each pair of computers can jointly sample the first pseudo-random key (s_{i,j}). In particular, for each pair of computers i,j∈[n] where i<j, the computers Pᵢ and Pⱼ jointly sample the first PRF key s_{i,j}←{0,1}^{K}.

The second pseudo-random key (sⱼ) can be generated by a set of computers. Each computer in the network of computers can be in a set (e.g., subset) of computers in the network. For example, the network can include 10 computers and 2 sets of computers that each comprise 5 computers. Each set of computers can jointly sample the second pseudo-random key (sⱼ) with the set of computers (Dⱼ) of multiple sets.

For example, a pair of computers (Pᵢ and Pⱼ) (e.g., such as the first computer 302 and the second computer 304) can jointly sample a first PRF key (s_{i,j}), and computers in each set of computers (Dⱼ) can sample a second PRF key (sⱼ). As such, each computer in the network can obtain two keys, where each key is shared between at least two computers.

At step 315, the first computer 302, the second computer 304, and the third computer 306 can locally generate replicated shares of a random value (r) by generating each share (rⱼ) at random using the second pseudo-random key (sⱼ). Each computer in the network can obtain a share [symbol] ^{R} of the random value (r). The shares may differ from computer to computer.

The computers can sample to random values in any suitable manner. As an example, each computer can maintain a counter (cnt) that can be used as input to a pseudo-random function number generator along with the second pseudo-random key (sⱼ). For example, each computer can sample [symbol] ^{R} such that rⱼ:=PRFₛ_{ⱼ}(cnt).

At step 320, the first computer 302, the second computer 304, and the third computer 306 can locally can use the first pseudo-random keys (s_{i,j}) to generate a replicated sharing of zero (e.g., an n-out-of-n secret sharing of zero, which is represented by β). For example, each computer can generate a preprocessing zero value (γ_{i,j}). One half of the computers can generate positive preprocessing zero values (γ_{i,j}), while the other half of the computers can generate negative preprocessing zero values (γ_{i,j}). For example, computers j∈[1, i) can generate a positive preprocessing value (γ_{i,j}), while computers j∈(i, n] can generate a negative preprocessing value (γ_{i,j}). Each preprocessing zero value (γ_{i,j}) can be generated using the first PRF key (s_{i,j}) and the counter (cnt). Each computer can then communicate with the other computers in their set of computers to obtain each preprocessing zero value (γ_{i,j}) from the set. The replicated sharing of zero (β) can be determined based on the preprocessing zero values (γ_{i,j}) from the set. For example, the replicated sharing of zero (β) can be equal to the summation of the preprocessing zero values (γ_{i,j}) from the set (e.g., βᵢ:=Σ_{j∈[n]/i} γ_{i,j}).

At step 325, the first computer 302, the second computer 304, and the third computer 306 can locally compute a masked share (z′ᵢ). The masked share (z′ᵢ) can be the product of the first secret share ( [symbol] ⱼ) and the second secret share ( [symbol] ^{R}) masked with the replicated sharing value (β) and the replicated random shares of the random value ( [symbol] r [symbol] ^{R}). The first computer 302 can determine a first masked share (z′ᵢ₌₁), the second computer 304 can determine a second masked share (z′ᵢ₌₂), and the third computer 306 can determine a third masked share (z′ᵢ₌₃).In particular, each computer of the plurality of computers can determine the masked share as:

$${{z}^{′}}_{i} := ( {\sum }_{( j , j ′ ) ∈ {A}_{i}} {x}_{j} {y}_{j ′} ) + {\sum }_{j ∈ {B}_{i}} {r}_{j} + {β}_{i}$$

At step 330, the masked shares (z′ᵢ) computed by each computer in a set of computers (D₁) can be shared across the set of computer, such as the first computer 302, the second computer 304, and the third computer 306. Each computer in the set of computers (D₁) can obtain a set shared masked value (z′) from the masked shares (z′ᵢ) computed by each computer in the set of computers (D₁). The set shared masked value (z′) can be the same value held by each computer in the set of computers (D₁). This can be performed since the masked shares (z′₁, . . . , z′ₙ) can be an n-out-of-n secret sharing of the set shared masked value z′. The set shared masked value z′ can be reveal to each computer in the set of computers (e.g., Pᵢ∈D₁). The masked shares (z′ᵢ) can appear to be sufficiently random to all the computers in the set of computers.

At step 335, after receiving the masked shares (z′ᵢ) from each computer within the set of computers (D₁), the first computer 302, the second computer 304, and the third computer 306 can generate replicated secret share [symbol] z [symbol] ^{R}. The replicated secret share can be generated based on the received plurality of masked shares (z′ᵢ) and the replicated random shares of the random value ( [symbol] r [symbol] R).

In some embodiments, the first computer can determine the first replicated share of the output value [symbol] z [symbol] R based on a masked value (z′) created from the masked shares (z′ᵢ), the decimal bit (d), and the first computer's share of the random value (rᵢ). In particular, the first computer can determine the first replicated share of the output value [symbol] z [symbol] ^{R} by performing z₁:=z′/d−r₁/d. The other computers can respectively determine the other replicated shares of the output value [symbol] z [symbol] ^{R} based on the shares of the random value (rⱼ) held by that computer and the decimal bit (d). In particular, the other computers can determine the replicated shares of the output value [symbol] z [symbol] ^{R} by performing zⱼ:=−rⱼ/d.

TABLE 6
Protocol for fixed point multiplication with replicated secret shares
against semi-honest adversaries.
Π_{RShare-Mul}( [symbol] ^{R}, [symbol] ^{R}, d)

```
The protocol outputs [symbol]  z [symbol]  ^{R} where z ≈ xy/d.
The security and correctness depends on |x|, |y| < 2^{k′} and |xy| < 2^{k′}
when multiplied over the integers and k ≥ (k′ + λ + log₂(m)).
    Let PRF: {0, 1}^{κ} × {0, 1}* → [symbol]  _{₂}_{k-log}_{₂}₍ₘ₎ and [symbol]
: {0, 1}^{κ} × {0, 1}* → [symbol]  ₂_{^{k}} be pseudorandom functions.
  Let A₁, . . . , Aₙ ⊂ [m]² be disjoint and cover [m]² such that (j, j′) ∈
Aᵢ only if i ∈ Dⱼ and i ∈ D_{j′}.
  Let B₁, . . . , Bₙ ⊂ [m] be disjoint and cover [m].
Setup. In the setup phase:
    For each pair i, j ∈ [n] where i < j, parties Pᵢ, Pⱼ jointly sample
    s_{i,j} ← {0, 1}^{κ}.
    Parties Pᵢ ∈ Dⱼ jointly sample key sⱼ ← {0, 1}^{κ}.
    All parties keep a counter cnt: = 0.
Multiply. Upon input shares [symbol]  ^{R}, [symbol]  ^{R} ∈ [symbol]  ₂_{^{k}}, parties compute
the product as follows:
    1. The parties sample [symbol]  r [symbol]  ^{R} such that rⱼ: = PRFₛ_{ⱼ}(cnt).
    2. Then, they compute an n-out-of-n secret sharing of 0 where
    Pᵢ's share βᵢ is computed as follows: Define γ_{i,j}: = [symbol]  ₛ_{_{j,i}}(cnt)
    for j ∈ [1, i) and γ_{i,j}: = − [symbol]  ₛ_{_{i,j}}(cnt) for j ∈ (i, n].
    Set βᵢ: = Σ_{j∈[n]/i} γ_{i,j}.
    3. Each Pᵢ computes the sum of their local crossterms as follows:
        ${z}_{i}^{′} : = ( {\sum }_{( j , j ′ ) ∈ {A}_{i}} {x}_{j} {y}_{j ′} ) + {\sum }_{j ∈ {B}_{i}} {r}_{j} + {β}_{i}$
      where Pᵢ's share [symbol]  ᵢ^{R} = {xⱼ|i ∈ Dⱼ} (resp. [symbol]  y [symbol]  ^{R}).
    4. Let (z′₁, . . . , z′ₙ) be an n-out-of-n secret sharing of z′.
    Reveal z′ to Pᵢ ∈ D₁.
    5. The parties output [symbol]  z [symbol]  ^{R} where z₁: = z′/d − r₁d and zⱼ: =
    −rⱼ/d for j ∈ [2, m] and increment cnt: = cnt + 1.
```

A tradeoff between the number of rounds and the number of messages per communication can be made in the protocol illustrated in Table 6. In the multiply phase, the protocol utilizes one round of communication. However, each computer sends its share of the masked share z′ to every computer in the set D₁ and so the total number of messages exchanged is n·(n−t) which is quadratic in the number of computers. Alternatively, other embodiments can have a two-round protocol where, in the first round, all computers can send their shares of the masked share z′ only to one computer (e.g., a leader computer P₁) in the set of computers D₁. The leader computer can then forward the masked share z′ to the other computers in the set of computers D₁. This reduces the number of messages to (n−1)+(n−t−1), which is linear in the number of computers present.

In terms of being information theoretic, computational assumptions are used for the PRF. However, the use of a PRF is utilized to reduce communication. In fact, to make the protocol completely information theoretic, embodiments can replace the PRF calls by having one computer pick (e.g., generate or otherwise obtain) the corresponding random string and share it with the others (at the cost of more communication).

### B. Replicated Secret Sharing: Malicious

This section builds on the replicated secret sharing methods in the semi-honest setting from the previous section to describe a protocol for fixed point multiplication with replicated secret sharing in the presence of a malicious adversary. It is then shown how to incorporate this into a general MPC protocol to compute any arithmetic circuit.

Multiplication can be performed on two values represented using replicated secret sharing for any n-parties where n≥3. First, a multiplication protocol in such a secret shared setting will be discussed in reference to Tables 10 and 11. Then, a fixed point multiplication with truncation protocol will be described with this multiplication protocol as a sub-routine, in reference to Table 9.

The fixed point multiplication method can include a first secret value x and a second secret value y, and let a ring be [symbol] ₂_{^{k}}. Computers in a system can have replicated secret shares [symbol] ^{R} and [symbol] ^{R} of the first secret value x and the second secret value y, respectively. The computers can attempt to compute a replicated secret share Q where the output value z is the product of the first secret value x and the second secret value y (e.g., z≈xy). Replicated multiplication can logically be split into two parts: (1) locally computing a n-of-n additive sharing of the product and (2) “promoting” the n-of-n share into a replicated sharing. The replicated multiplication protocol is illustrated in Table 7, while the “promote” protocol is illustrated in Table 8.

TABLE 7
Π_{RShare-Mul}( [symbol] ^{R}, [symbol] ^{R})
Protocol for multiplication with replicated secret shares

```
Protocol for multiplication with replicated secret shares.
The protocol outputs [symbol]  z [symbol]  ^{R} where z ≈ xy.
Let [symbol]  : {0, 1}^{κ} × {0, 1}* → [symbol]  ₂_{^{k}} be a pseudorandom function.
Let A₁, . . . , Aₙ ⊂ [m]² be disjoint and cover [m]² such that (j, j′)
∈ Aᵢ only if i ∈ Dⱼ and i ∈ D_{j′}.
Setup: For each pair i, j ∈ [n] where i < j, parties Pᵢ , Pⱼ jointly sample
  s_{i,j} ← {0, 1}^{κ}. All parties keep a counter cnt: = 0.
Multiply: Upon input shares [symbol]  ^{R}, [symbol]  ^{R}, parties compute the
product as follows:
  1. Each party Pᵢ defines r′_{i,j}: = [symbol]  ₛ_{_{j,i}}(cnt) for j ∈ [1, i) and r′_{i,j}: =
    − [symbol] ₛ_{_{j,i}}(cnt) for j ∈ (i, n]. Set rᵢ: = Σ_{j∈[n]/i} r′_{i,j}.
  2. Each Pᵢ computes the sum of their local crossterms as follows:
      ${z}_{i}^{′} : = ( {\sum }_{( j , j ′ ) ∈ {A}_{i}} {x}_{j} {y}_{j ′} ) + {r}_{i}$
    where Pᵢ's share [symbol]  ᵢ^{R} = {xⱼ|i ∈ Dⱼ} (resp. [symbol]  ^{R}).
  3. The parties invoke protocol Π_{Promote}^{R} (in Table 8) where Pᵢ inputs
    z′ᵢ and receives [symbol]  z [symbol]  ᵢ^{R} where z is defined as z = Σ_{j∈[n]} z_{j′}.
    The parties output [symbol]  z [symbol]  ^{R} and increment cnt: = cnt + 1.
```

```
TABLE 8
Protocol for promoting an n-out-of-n sharing into a replicated secret sharing.
Π_{Promote}^{R}( [symbol]   z′ [symbol]   )
- The protocol outputs [symbol]    z [symbol]   ^{R}.
- Let PRF: {0,1}^{K} × {0,1}* → [symbol]    _{₂}ₖ be a pseudorandom function.
- Let N₁, ... , Nₙ ⊏ (n, m] be equal sized and disjoint sets such that j ϵ Nᵢ only if i ϵ Dⱼ.
Setup: For each j ϵ (n, m], the parties {Pᵢ|i ϵ Dⱼ} jointly sample sⱼ ← {0,1}^{K}. All parties keep a
  counter cnt: = 0.
Promote: Upon input zᵢ, from Pᵢ, parties compute the product as follows:
  1. For each j ϵ (n, m], the parties {Pᵢ|i ϵ Dⱼ} define zⱼ: = PRFₛⱼ (cnt).
  2. For each i ϵ [n], Pᵢ defines zᵢ: = zᵢ − Σ_{jϵN}_{ᵢ} zⱼ and sends it to {Pᵢ|i′ ϵ Dᵢ}.
  3. Party Pᵢ outputs their share [symbol]    z [symbol]   ᵢ^{R}: = {zⱼ|i ϵ Dⱼ} and increments cnt: = cnt + 1.
```

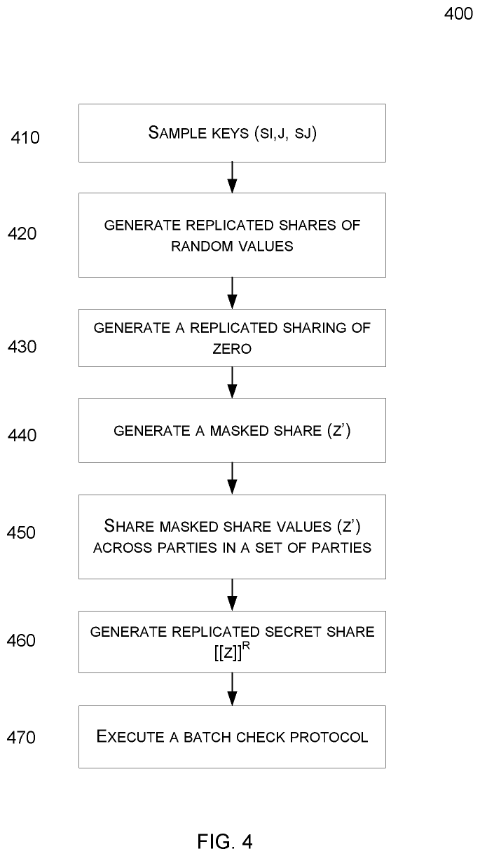

FIG. 4 illustrates a block diagram 400 illustrating an example replication method for multi-party fixed point multiplication. The method illustrated in FIG. 4 will be discussed in reference to Table 9.

Prior to step 410, each computer can store a first secret value share xⱼ from a first secret value x of a first replicated secret share [symbol] ^{R} and a second secret value share yⱼ from a second secret value y of a second replicated secret share [symbol] ^{R}.

At step 410, each computer can sample a first pseudorandom key (s_{i,j}) and a second pseudorandom key (sⱼ). The first pseudorandom key (s_{i,j}) can bejointly sampled by a pair of computers (Pᵢ and Pⱼ). The second pseudorandom key (sⱼ) can be sampled by the set of computers in each set (Dⱼ). The sampling of keys is discussed in a setup phase in Table 9.

Each computer can locally store a counter that can be incremented, decremented, and reset equally by each computer. The counters can allow the computers to remain in sync in regards to pseudorandom function generators and any other processes that utilize an incremental value.

At step 420, after generating the first pseudorandom key (s_{i,j}) and the second pseudorandom key (sⱼ), each computer can generate replicated shares of a first random value (r) and a second random value (r′).

The first random value (r) can be sampled by each computer to obtain a first random value share (rⱼ). The first random value share (rⱼ) can be generated using a pseudorandom function generator based on the second pseudorandom key (sⱼ). The pseudorandom function generator can also accept the counter as input.

The second random value (r′) can be generated by each computer to obtain a second random value share (r′ⱼ) based on the first random value share (rⱼ) and a decimal bit value d that can denote a decimal value. In particular, the second random value share (r′ⱼ) can be determined by dividing the first random value share (rⱼ) by the decimal bit value d.

At step 430, after generating the random value shares, the computers can generate a replicated sharing of zero (or an n-out-of-n secret sharing of zero). The replicated sharing of zero can be created based on the first pseudorandom keys (s_{i,j}). The replicated sharing of zero is represented by β, where each βᵢ lies in the ring Z₂ₖ. In particular, the replicated sharing of zero (βᵢ) can be generated by performing the following: define γ_{i,j}:= [symbol] ₛ_{_{j,i}}(cnt) for j∈[1, i) and γ_{i,j}: — [symbol] ₛ_{_{i,j}}(cnt) for j∈(i, n], and then set βᵢ:=Σ_{j∈[n]/i} γ_{i,j}.

At step 440, after generating the replication sharing of zero, the computers can generate a masked share (z′ᵢ). The masked share (z′ᵢ) can provide the combination of values (x, y) that is masked by the share of zero. The masked share (z′ᵢ) can be generated based on the first secret value share xⱼ, the second secret value share yⱼ, the first random value share (rⱼ), and the replicated sharing of zero (βᵢ). In particular, each computer can compute:

$${{z}^{′}}_{i} := ( {\sum }_{( j , j ′ ) ∈ {I}_{i}} {x}_{j} {y}_{j ′} ) + {\sum }_{j ∈ {B}_{i}} {r}_{j} + {β}_{i}$$

In some embodiments, the computers can jointly sample replicated secret shares of a MAC key ( [symbol] α [symbol] ^{R}), where a is randomly sampled. The MAC α can be added with the masked share z′. In instances where a covert adversary may be included as a computer, the masked share z′ with an added MAC α can be processed using a batch check process (e.g., at 470) to determine that the MAC αz′ was correctly generated, detecting whether a computer cheated or did not entirely follow the protocol.

At step 450, after generating the masked share (z′ᵢ), a set shared masked share (z′) (which can be a set shared value that is shared by each computer in the set) can be determined by each computer in each set of computers (Dᵢ), which can be shared across the computers in the set of computers (Dᵢ). The computers may observe that the masked shares may appear to be sufficiently random to all of the computers in the set of computers. For example, each computer can share their generated masked share (z′ᵢ) with the computer's set of computers. Upon receiving each masked share (z′ᵢ) from the computers in the set of computers, each computer in the set of computers can obtain the set shared masked share (z′) from the plurality of masked shares (z′ᵢ).

At step 460, after obtaining the set shared masked share (z′), each computer can generate replicated secret shares [symbol] z [symbol] ^{R}. This can be performed using the set shared masked shares (z′), the first random value share (rⱼ), and the decimal bit value (d). In some embodiments, the first computer can determine the first replicated secret share z₁ based on the set shared masked share (z′), the decimal bit value (d) and the first share of the first random value (r₁). For example, the first computer can determine the first replicated secret share z₁ by performing z₁:=z′/d−r₁/d. The other computers of the plurality of computers can generate their shares of the replicated secret share [symbol] z [symbol] ^{R} based on their respective shares of the first random value share (rⱼ) and the decimal bit value (d). For example, the other computers can determine the their replicated secret share zⱼ by performing z:=−rⱼ/d.

In some embodiments, the replicated secret shares [symbol] z [symbol] ^{R} can be generated based on removing a MAC key α from a received masked replicated secret share [symbol] αz [symbol] ^{R}.

In some embodiments, at step 470, replicated secret shares of the MAC key ( [symbol] α [symbol] ^{R}) can be checked for consistency using a batch check protocol to ensure that masked shares (z′) were correctly opened using ( [symbol] αz′ [symbol] ^{R}). Executing the batch check protocol can identify any adversarial parties that attempted to provide a masked value z′ maliciously, as such an adversarial computer would not know the MAC key (a).

For example, in some embodiments, can perform a MAC check to further increase security of the system. Consider the two fixed point values x, y represented in twos-complement form in [symbol] ₂_{^{k}}, where the bottom d bits denote the decimal. The computers hold replicated secret shares [symbol] ^{R}, [symbol] ^{R} in an extended ring [symbol] ₂_{^{k}} where k≥(k′+2λ+log₂(m)). The computers can attempt to compute a replicated secret share [symbol] z [symbol] ^{R} where the output value

$$z \approx \frac{xy}{{2}^{d}} ∈ {𝕊}_{{2}^{k ′}} .$$

The protocol works among n computers P₁, . . . , Pₙ over an extended ring [symbol] ₂_{^{k}}.

$$Let m := ( \begin{matrix}n \\ n - t\end{matrix} )$$

and D₁, . . . , Dₘ⊂[n] be the m distinct subsets of computers of size (n−t). In some embodiments, prior to the execution of the fixed point multiplication protocol (and as part of the overall MPC protocol), the computers can jointly sample replicated secret shares of a MAC key [symbol] α [symbol] ^{R}, where α is randomly sampled from [symbol] ₂_{^{k}}. Then, the computers generate shares of the MAC of one of the inputs [symbol] ^{R} using the protocol in Table 9.

Embodiments can instantiate functionality [symbol] _{MAC.Check} using the “MAC Check” protocol in FIG. 10 of [23].

TABLE 9
Protocol for fixed point multiplication with replicated secret
shares against malicious adversaries
Π_{RShare-Mul-Mal}( [symbol] a [symbol] ^{R}, [symbol] x [symbol] ^{R}, [symbol] ax [symbol] ^{R}, [symbol] y [symbol] ^{R}, d)

```
The protocol outputs [symbol]  z [symbol]  ^{R}, [symbol]  az [symbol]  ^{R} where z ≈ xy/d.
Let PRF: {0, 1}^{κ} × {0, 1}* = → [symbol]  _{₂}_{k-log}_{₂}_{(m)-λ} and [symbol]
: {0, 1}^{κ} × {0, 1}* → [symbol]  _{₂}ₖ be pseudorandom functions.
Let A₁, . . . , Aₙ ⊂ [m]² be disjoint and cover [m]² such that
(j, j′) ∈ Aᵢ only if i ∈ Dⱼ and i ∈ D_{j′}.
Let B₁, . . . , Bₙ ⊂ [m] be disjoint and cover [m].
Setup. In the setup phase:
  For each pair i, j ∈ [n] where i < j, parties Pᵢ , Pⱼ jointly sample
  s_{i,j} ← {0, 1}^{κ}.
  Parties Pᵢ ∈ Dⱼ jointly sample key sⱼ ← {0, 1}^{κ}. All parties
  keep a counter cnt: = 0.
Multiply. Upon input shares [symbol]  a [symbol]  ^{R}, [symbol]  x [symbol]  ^{R}, [symbol]  ax [symbol]  ^{R}, [symbol]  y [symbol]  ^{R} ∈ [symbol]
₂_{^{k}}, parties compute the product as follows:
  1. The parties sample [symbol]  r [symbol]  ^{R}, [symbol]  r′ [symbol]  ^{R} such that rⱼ: = PRFₛ_{ⱼ}(cnt)
    and r′ⱼ: = rⱼ/d. Compute [symbol] αr [symbol]  ^{R}, [symbol]  αr′ [symbol]  ^{R}, using the
    multiplication protocol in Table 7.
  2. Then, they compute an n-out-of-n secret sharing of 0 where Pᵢ's
    share βᵢ is computed as follows: Define γ_{i,j}: = [symbol]  ₛ_{_{j,i}}(cnt) for j ∈
    [1, i) and γ_{i,j}: = − [symbol]  ₛ_{_{i,j}}(cnt) for j ∈ (i, n].
    Set βᵢ: = Σ_{j∈[n]/i} γ_{i,j}.
  3. Each Pᵢ computes the sum of their local crossterms as follows:
      ${z}_{i}^{′} : = ( {\sum }_{( j , j ′ ) ∈ {I}_{i}} {x}_{j} {y}_{j ′} ) + {\sum }_{j ∈ {B}_{i}} {r}_{j} + {β}_{i}$
      ${( α {z}^{′} )}_{i} := ( {\sum }_{( j , j′ ) ∈ {I}_{i}} {( α x )}_{j} {y}_{j′} ) + {\sum }_{j ∈ {B}_{i}} {( α r )}_{j} + {β}_{i}$
    where Pᵢ's share [symbol]  x [symbol]  ᵢ^{R} = {xⱼ|i ∈ Dⱼ} (resp. [symbol]  y [symbol]  ^{R}).
  4. The n-out-of-n secret sharing z′ is revealed to all parties.
  5. Invoke functionality [symbol]  _{MAC.Check} (Table 10). Each Pᵢ inputs
    (z′, (αz′)ᵢ, αᵢ*) where αᵢ* is the share of [symbol]  a [symbol]  ^{R} held by Pᵢ
    corresponding to set Dᵢ. Abort the protocol if it returns “Abort”.
  6. The parties increment cnt: = cnt + 1 and output [symbol]  αz [symbol]  ^{R}, [symbol]  z [symbol]  ^{R}
    where
    z₁: = z′/d − r₁/d and zⱼ: = −rⱼ/d for j ∈ [2, m] [symbol]
    αz [symbol]  ^{R}: = [symbol]  α [symbol]  ^{R}(z′/d) − [symbol]  αr′ [symbol]  ^{R}
```

TABLE 10
Ideal functionality for checking the MAC on a secret shared value. [symbol]
_{MAC.Check}
Input: Each party Pᵢ has input (z′, σᵢ, αᵢ).
Computation: Reconstruct α from shares {αᵢ}_{iϵ[n]} and σ from {(σ)ᵢ}_{iϵ[n]}. Output “Abort” to
all parties if σ ≠ (α · z′).

TABLE 11
Protocol for MPC with replicated secret sharing against
malicious adversaries.
Π_{RShare-MPC-Mal}

```
  The protocol works among n parties P₁, . . . , Pₙ over an extended ring
${𝕊}_{{2}^{k}} . Let m := ( \begin{matrix}n \\ n - t\end{matrix} ) and {D}_{1} , … , {D}_{m} ⊂ [ n ] be the m distinct$
subsets of size (n − t). For each j ∈ [m], let Sⱼ be the set of parties
indexed by Dⱼ.
  During the circuit computation, all the inputs and outputs of every
multiplication gate have absolute value < 2^{k′} where k ≥ (k′ + λ +
log₂(m)).
Setup: Jointly sample α ∈ [symbol]  ₂_{^{λ}} and generate [symbol] α [symbol]  ^{R}. Each party
Pᵢ gets [symbol]  α [symbol]  ᵢ^{R}: = {αᵢ | i ∈ Dⱼ}.
  Then, run the setup of protocol Π_{RShare-Mul} in Table 6.
Share: Every party P ∈ {P₁, . . . , Pₙ} shares an input value x ∈ [symbol]  ₂_{^{k′}}
as follows:
  1. Sample x₁, . . . , xₘ ← [symbol]  ₂_{^{k}} such that x = Σ_{i∈[m]} xᵢ.
  2. Send xⱼ to all parties Pᵢ such that i ∈ Dⱼ. Each party Pᵢ sets [symbol]
    x [symbol]  ᵢ^{R}: = {xᵢ | i ∈ Dⱼ}.
  3. Run any MPC protocol (e.g. [28]) to compute functionality [symbol]  _{Range}
    (Table 12) where Pᵢ's input is [symbol]  x [symbol]  ᵢ^{R}.
  4. Run the multiplication protocol Π_{RShare-Mul} (FIG. 10) where
    each Pᵢ's input is ( [symbol] x [symbol]  ᵢ^{R}, [symbol]  α [symbol]  ᵢ^{R}) and output is [symbol]  αx [symbol]  ᵢ^{R}.
Linear operations: For any constant c and share ( [symbol]  y [symbol]  ^{R}, [symbol]  αy [symbol]  ^{R}),
    parties perform linear operations on share ( [symbol]  x [symbol]  ^{R}, [symbol]  αx [symbol]  ^{R})
    to compute the output ( [symbol]  z [symbol]  ^{R}, [symbol]  αz [symbol]  ^{R}), as follows:
  1. Addition by a constant c:
    z₁ = x₁ + c, (αz)₁ = (αx)₁ + c · α₁,
    zⱼ = xⱼ, (αz)ⱼ = (αx)ⱼ + c · αⱼ for j ∈ [m]/1
  2. Addition of shares: zⱼ = xⱼ + yⱼ, (αz)ⱼ = (αx)ⱼ + (αy)ⱼ for j ∈ [m]
  3. Multiplication by a constant c: z_{j; = cxj}, (αz)ⱼ = c · (αx)ⱼ for j ∈ [m]
Fixed point multiplication: For any two shares ( [symbol]  x [symbol]  ^{R}, [symbol]  y [symbol]  ^{R},
    parties perform fixed point multiplication by running the multiply
    phase of Π_{RShare-Mul} in Table 9.
Output reconstruction: Each party Pᵢ holds [symbol]  z [symbol]  ᵢ^{R} and publicly
    reconstructs z as follows:
  1. For j ∈ [m], (t + 1) of the parties in set Dⱼ reveal zⱼ to everyone
    (can order each set and the first (t + 1) parties speak).
  2. Abort if there is inconsistency in any zⱼ. Else, compute output
  z = Σ_{i∈[m]}_{^{zi}}.
```

In addition to the protocol for semi-honest security, embodiments can add an information theoretic MAC αz′ along with the term z′. Then, since α is unknown to the adversary, if the MAC Check protocol does not abort, there is a guarantee that the term z′ was correctly computed by the adversary. Finally, after computing [symbol] z [symbol] ^{R} as in the semi-honest protocol, embodiments can now also compute the MAC [symbol] αz [symbol] .

### V. SHAMIR SECRET SHARING PROTOCOL FOR MULTI-PARTY FIXED POINT MULTIPLICATION

Some embodiments can provide for a semi-honest protocol for fixed point multiplication with Shamir secret sharing.

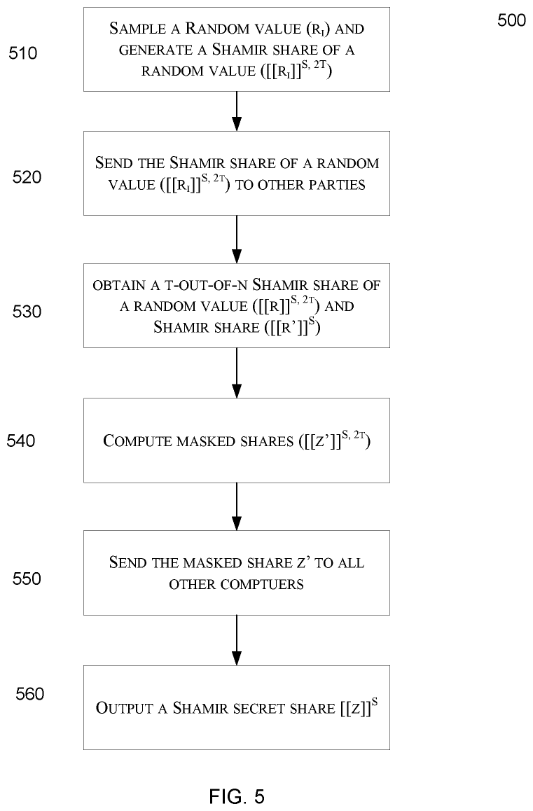

FIG. 5 illustrates a block diagram 500 of an example Shamir sharing protocol for multi-party fixed point multiplication.

Prior to step 510, each computer can obtain two fixed point values, a first secret value x and a second secret value y, where x, y∈ [symbol] ₂_{^{k}}. The first secret value x and the second secret value y can be held by computers in a network comprising a plurality of computers via Shamir secret sharing [symbol] ^{S}, [symbol] ^{S} on a field [symbol] _{q}, where q≥2^{k′+λ}·(t+1). As such, each computer can hold one share of the first secret value and one share of the second secret value. For each multiplication that occurs between secret values (e.g., when multiplying the first secret value x and the second secret value y), the computers can attempt to learn a Shamir secret share of the product [symbol] z [symbol] ^{S}, where z≈xy/d. This method will be described in reference to Table 13.

For each fixed point multiplication, each computer of the plurality of computers can first perform preprocessing where the computer obtains a 2t-out-of-n Shamir secret sharing of a first random value [symbol] r [symbol] ^{S,2t} in the field [symbol] _{q} and a t-out-of-n Shamir secret sharing of a second random value [symbol] r′ [symbol] ^{S} in the field [symbol] _{q}. The first random value r is mathematically related to the second random value r′, in particular where r′=r/d. The first random value r and the second random value r′ are generated as a summation of n random values, namely r=Σ_{i∈[n]} rᵢ and r′=Σ_{i∈[n]} r′ᵢ, where r′ᵢ=rᵢ/d and they are contributed by all the computers in the network. There is no overflow in the summation due to sampling rᵢ from [symbol] ₂_{^{k′+λ}}. Once the double sharing with truncation is generated, the rest of the protocol follows from the multiplication techniques for Shamir secret sharing.

In particular, at step 510, a computer (Pᵢ) can sample a random value (rᵢ) and generate a Shamir share of a first random value (rᵢ) to obtain a first random share ( [symbol] rᵢ [symbol] ^{S,2t}). Each computer in the network of computers can generate the first random share ( [symbol] rᵢ [symbol] ^{S,2t}) of the random value (rᵢ) and a second random share ( [symbol] rᵢ/d [symbol] ^{S}), where the first random share ( [symbol] rᵢ [symbol] ^{S,2t}) is determined using 2t-out-of-n sharing. The second random share ( [symbol] rᵢ/d [symbol] ^{S}) can be generated based on the first random share and a decimal bit value (d).

At step 520, after generating the first random share ( [symbol] rᵢ [symbol] ^{S,2t}), each computer can send the first random share ( [symbol] rᵢ [symbol] ^{S,2t}) and the second random share ( [symbol] rᵢ/d [symbol] ^{S}) to the other computers in the computer network.

At step 530, after receiving each share of the first random share ( [symbol] rᵢ [symbol] ^{S,2t}) and each share of the second random share ( [symbol] rᵢ/d [symbol] ^{S}), each computer can obtain a t-out-of-n Shamir share of a third random share ( [symbol] r [symbol] ^{S,2t}) and a fourth random share ( [symbol] r′ [symbol] ^{S}).

The third random share ( [symbol] r [symbol] ^{S,2t}) can be generated based on each share of the first random share ( [symbol] rᵢ [symbol] ^{S,2t}). For example, the third random share ( [symbol] r [symbol] ^{S,2t}) can be equal to a summation of each share of the first random share ( [symbol] rᵢ [symbol] ^{S,2t}).

The fourth random share ( [symbol] r′ [symbol] ^{S}) can be generated based on each share of the second random share ( [symbol] rᵢ/d [symbol] ^{S}). For example, the fourth random share ( [symbol] r′ [symbol] ^{S}) can be equal to a summation of each share of the second random share ( [symbol] rᵢ/d [symbol] ^{S}).

At step 540, each computer can compute masked shares ( [symbol] z′ [symbol] ^{S,2t}). The masked shares can provide a fixed-point multiplication (of x, y) masked with the third random share ( [symbol] r [symbol] ^{S,2t}) Each computer can determine the masked share ( [symbol] z′ [symbol] ^{S,2t}) based on the first secret share ( [symbol] x [symbol] ^{S}), the second secret share ( [symbol] y [symbol] ^{S}), and the third random share ( [symbol] r [symbol] ^{S,2t}). For example, each computer can determine the masked share ( [symbol] z′ [symbol] ^{S,2t}) by multiplying the first secret share ( [symbol] x [symbol] ^{S}) and the second secret share ( [symbol] y [symbol] ^{S}) and then adding in the third random share ( [symbol] r [symbol] ^{S,2t}).

At step 550, each computer in the network of computers can send the masked share ( [symbol] z′ [symbol] ^{S,2t}) to a leader computer (e.g., Pᵢ), which can, in turn, determine the masked value (z′) from the masked shares ( [symbol] z′ [symbol] ^{S,2t}). The leader computer can then send the masked value (z′) to all other computers in the network. The masked value z′ may appear sufficiently random to other receiving computers.

Specifically, a first computer P₁ can learn a masked value z′=x·y+r and send it to all the other computers of the plurality of computers. Although the first random value r is not entirely uniform in the field [symbol] _{q}, its sampling space is sufficiently larger than the value of x·y and it is in fact statistically close to a uniform distribution, hence the masked value z′ looks sufficiently random to all the computers.

At step 560, each computer can then output a Shamir secret share [symbol] z [symbol] ^{S} using the received value z′ and Shamir share [symbol] r′ [symbol] ^{S}. By the correctness of double sharing with truncation for the first random value r and the second random value r′, all of the computers can obtain the sharing of [symbol] ^{S} by taking z′/d− [symbol] r′ [symbol] ^{S}.

TABLE 12
Ideal functionality for checking the range of a secret shared value [symbol]
_{Range}
Parameters: Ring [symbol] _{₂}ₖ and a value k′ < k.
Input: Each party Pᵢ has input [symbol] ᵢ^{R}.
Computation: Reconstruct x from the shares { [symbol] ᵢ^{R}}_{iϵ[n]}. Output “Abort” to all parties if x >
2^{k′}.

TABLE 13
Semi-honest protocol for fixed point multiplication with Shamir
secret shares.
Π_{SShare-Mul}( [symbol] ^{R}, [symbol] ^{R}, d)

```
The protocol outputs [symbol]   ^{S} where z ≈ xy/d.
The security and correctness of the protocol depends on |x|, |y| < 2^{k′}
  and |xy| < 2^{k′} when multiplied over the integers and q ≥ 2^{k′+λ} · (t + 1).
Preprocessing. For each fixed point multiplication:
  $1. The party {P}_{i} for i ∈ [ t + 1 ] samples {r}_{i} {←}^{\$} {𝕊}_{{2}^{{k}^{′} + λ}} , generates$ [symbol]
  rᵢ [symbol]  ^{S,2t}, [symbol] rᵢ/d [symbol]  ^{S} in [symbol]  _{q}, and sends the shares to the other parties.
  2. All parties locally compute r^{S,2t}: = Σ_{i∈[t+1]} [symbol]  rᵢ [symbol]  ^{S,2t}, [symbol] r′ [symbol]  ^{S}: =
  Σ_{i∈[t+1]} [symbol] ᵣᵢ/d [symbol]  ^{S}.
Multiply. Upon input shares [symbol]  x [symbol]  ^{S}, [symbol]  y [symbol]  ^{S} ∈ [symbol]  _{q}, parties compute
    the product as follows:
  1. All parties locally compute [symbol]  z′ [symbol]  ^{S,2t}: = [symbol]  x [symbol]  ^{S} · [symbol]  y [symbol]  ^{S} + [symbol]
    r [symbol]  ^{S,2t} and reveal z′ to P₁.
  2. P₁ sends z′ to all the parties.
  3. All parties output [symbol]  z [symbol]  ^{S}: = z′/d − [symbol]  r′ [symbol]  ^{S}.
```

The truncation technique, according to embodiments, does not have to follow a multiplication step and it does not necessarily require honest majority. It can be used as a general approach for truncating Shamir-shared value for any t<n.

In some embodiments, the computers can implement a semi-honest protocol for fixed point multiplication with Shamir secret sharing. The Shamir sharing protocol can include fixed point values (x, y) in two-complement form, where the computers hold Shamir secret shares [symbol] x [symbol] ^{R} and [symbol] y [symbol] ^{R}. For each fixed point multiplication, the computers may perform the protocol to obtain a Shamir secret share [symbol] z [symbol] ^{S}.

The MPC protocol with Shamir secret sharing leveraging the aforementioned fixed point multiplication protocol, presented in Table 14, can be used to compute any arithmetic circuit where multiplications are fixed point multiplication with truncation.

```
TABLE 14
Protocol for MPC with Shamir secret sharing.
Π_{SShare-MPC}
- The protocol works among n parties P₁, ... , Pₙ over a field [symbol]    _{q}.
- During the circuit computation, all the intermediate results have absolute value < 2^{k′}.
- q ≥ 2^{k′+λ} · (t + 1).
Share: For input value x ϵ [symbol]    _{₂}_{k′}, party Pᵢ generates a Shamir secret sharing [symbol]    ^{S} in the field [symbol]    _{q}
  and sends the shares to all the parties.
Linear operations: For any constant c and shares [symbol]    ^{S}, [symbol]    ^{S}, parties perform linear operations
  on share [symbol]    ^{S} as follows:
  1. Addition by a constant: [symbol]   x + c [symbol]   ^{S} = [symbol]    ^{S} + c
  2. Addition of shares: [symbol]    x + y [symbol]   ^{S} = [symbol]    ^{S} + [symbol]    ^{S}
  3. Multiplication by a constant: [symbol]    cx [symbol]   ^{S} = c · [symbol]    ^{S}
Fixed point multiplication: For any two shares [symbol]    ^{S}, [symbol]    ^{S}, parties perform fixed point
  multiplication as in Table 13
Reconstruct the output: Each party Pᵢ holds [symbol]    ⱼ^{S} and publicly reconstructs z as follows:
  1. For j ϵ [2, ... , t + 1], party Pⱼ sends [symbol]    ⱼ^{S} to P₁.
  2. P₁ holds t + 1 points and interpolates the polynomial p_{z}(·).
  3. P₁ sends z: = p_{z}(0) to all parties.
```

### VI. ADDITIVE SECRET SHARING FOR MULTI-PARTY FIXED POINT MULTIPLICATION

Embodiments provide for a semi-honest protocol for fixed point multiplication with additive secret sharing. Consider two fixed point values including a first secret value x and a second secret value y represented in twos-complement form in [symbol] ₂_{^{k′}}. Computers in a network of computers hold first additive secret shares [symbol] ^{A} and second additive secret shares [symbol] ^{A}, of the first secret value x and the second secret value y, respectively, in an extended ring [symbol] ₂_{^{k}} where k≥k′+λ+log₂n. Further, it can be assumed that the computers hold preprocessed Beaver triples of the form [symbol] α [symbol] ^{A}, [symbol] β [symbol] ^{A}, [symbol] γ [symbol] ^{A} in [symbol] ₂_{^{k}} where α,

$$β {←}^{\$} {𝕊}_{{2}^{k}}$$

and γ=α·β. The Beaver triples can include a secret share ( [symbol] α [symbol] ^{A}) of a third value (α), a secret share ( [symbol] β [symbol] ^{A}) of a fourth value (β), and a secret share ( [symbol] y [symbol] ^{A}) of a fifth value (γ). For each fixed point multiplication, the computers can attempt to determine an additive secret share [symbol] ^{A} where z≈xy/d, which is formally described with respect to Table 15.

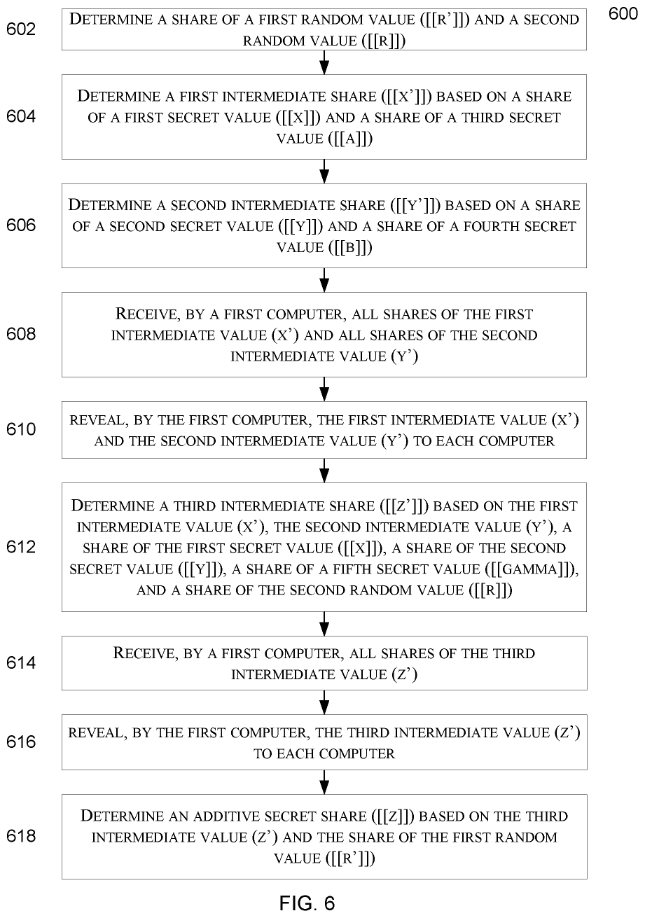

FIG. 6 illustrates a block diagram of an example additive sharing protocol for multi-party fixed point multiplication according to an embodiment of the present disclosure. The method illustrated in FIG. 6 can be performed by a first computer in a network comprising a plurality of computers.

Prior to step 602, each computer of the plurality of computers can obtain secret shares of a plurality of secret values and a decimal bit value (d). The secret shares can include a secret share ( [symbol] x [symbol] ^{A}) of a first value (x), a secret share ( [symbol] y [symbol] ^{A}) of a second value (γ), a secret share ( [symbol] α [symbol] ^{A}) of a third value (α), a secret share ( [symbol] β [symbol] ^{A}) of a fourth value (β), and a secret share ( [symbol] y [symbol] ^{A}) of a fifth value (γ). The computers of the plurality of computers can attempt to multiply the first value (x) and the second value (y). However, since each computer only stores the secret share ( [symbol] x [symbol] ^{A}) of the first value (x) and the secret share ( [symbol] y [symbol] ^{A}) of the second value (y), the computers can communicate with one another to perform the additive sharing protocol for multiparty fixed point multiplication in a secret sharing manner according to steps 602-620.

The shares held (e.g., stored) by each computer can be unique shares that differ from computer to computer. Therefore, when a share of a value is referred to, it is understood that the share of the value is different at different computers.

The secret share of the third value (α), the secret share of the fourth value (β), and the secret share of the fifth value (γ) make up a preprocessed Beaver triple. The first value (x) and the second value (y) are fixed point values represented in twos-complement form in a ring ( [symbol] ₂_{^{k′}}).

At step 602, each computer of the plurality of computers can determine a share of a first shared random value ( [symbol] r′ [symbol] ^{A}) and a share of a second shared random value ( [symbol] r [symbol] ^{A}). In some embodiments, the determination of the share of the first shared random value ( [symbol] r′ [symbol] ^{A}) and the share of the second shared random value ( [symbol] r [symbol] ^{A}) can be performed in a preprocessing step.

The computers can determine the first shared random value ( [symbol] r′ [symbol] ^{A}) and the share of the second shared random value ( [symbol] r [symbol] ^{A}) as follows. Each computer can sample an extended ring ( [symbol] ₂_{^{k′+λ}}) to generate shares of a first initial random value ( [symbol] ^{A}) and shares of a second initial random value ( [symbol] ^{A}). The shares of the second initial random value ( [symbol] rᵢ/d [symbol] ^{A}) can be created based on the shares of the first initial random value ( [symbol] ^{A}) and the decimal bit value (d). Each computer can then send the shares of the first initial random value ( [symbol] ^{A}) and the shares of the second initial random value ( [symbol] ^{A}) to the plurality of computers. After receiving the shares of the first initial random value ( [symbol] ^{A}) and the shares of the second initial random value ( [symbol] ^{A}), each computer can determine shares of the first shared random value ( [symbol] r′ [symbol] ^{A}) based on the shares of the second initial random value ( [symbol] ^{A}) (e.g., [symbol] r′ [symbol] ^{A}:=Σ_{i∈[t+1}] [symbol] ^{A}). Each computer can determine a share of the second shared random value ( [symbol] r [symbol] ^{A}) based on the shares of the first shared random value ( [symbol] r [symbol] ^{A}) (e.g., [symbol] r [symbol] ^{A}:=Σ_{i∈[t+1}] [symbol] r′ [symbol] ^{A}).

At step 604, after determining the shares of the first shared random value ( [symbol] r′ [symbol] ^{A}) and the second shared random value ( [symbol] r [symbol] ^{A}), each computer of the plurality of computers can determine a first intermediate share ( [symbol] x′ [symbol] ^{A}) based on the secret share ( [symbol] x [symbol] ^{A}) of the first value (x) and the secret share ( [symbol] α [symbol] ^{A}) of the third value (α). For example, each computer can determine the first intermediate share ( [symbol] x′ [symbol] ^{A}), held by that computer, by adding the secret share ( [symbol] x [symbol] ^{A}) of the first value (x) and the secret share ( [symbol] α [symbol] ^{A}) of the third value (α) (e.g., [symbol] x′ [symbol] ^{A}:= [symbol] x [symbol] ^{A}+ [symbol] α [symbol] ^{A}). The addition of the secret share ( [symbol] a [symbol] ^{A}) of the third value (α) can mask the secret share ( [symbol] x [symbol] ^{A}) of the first value (x).

At step 606, after determining the first intermediate share ( [symbol] x [symbol] ^{A}), each computer of the plurality of computers can determine a second intermediate share ( [symbol] y [symbol] ^{A}) based on the secret share ( [symbol] y [symbol] ^{A}) of the second value (y) and the secret share ( [symbol] β [symbol] ^{A}) of the fourth value (β). For example, each computer can determine the second intermediate share ( [symbol] y′ [symbol] ^{A}), held by that computer, by adding the secret share ( [symbol] y [symbol] ^{A}) of the second value (y) and the secret share ( [symbol] β [symbol] ^{A}) of the fourth value (β) (e.g., [symbol] y′ [symbol] ^{A}:= [symbol] y [symbol] ^{A}+ [symbol] β [symbol] ^{A}). The addition of the secret share ( [symbol] β [symbol] ^{A}) of the fourth value (β) can mask the secret share ( [symbol] y [symbol] ^{A}) of the second value (y).

At step 608, after each computer of the plurality of computers determines the first intermediate share ( [symbol] x′ [symbol] ^{A}) and the second intermediate share ( [symbol] y′ [symbol] ^{A}), each computer can send the first intermediate share ( [symbol] x [symbol] ^{A}) and the second intermediate share ( [symbol] y′ [symbol] ^{A}) to the first computer. In some embodiments, the first computer can be referred to as a leader computer.

The first computer can receive each of the first intermediate shares ( [symbol] x′ [symbol] ^{A}) of the first intermediate value (x′) from the network of computers, thus revealing the first intermediate value (x′) in the clear to the first computer. The first computer can receive each of the second intermediate shares ( [symbol] y′ [symbol] ^{A}) of the second intermediate value (y′) from the network of computers, thus revealing the second intermediate value (y′) in the clear to the first computer.

The first computer can reconstruct the first intermediate value (x′) and the second intermediate value (y′) as described in detail herein according to additive secret sharing techniques.

At step 610, after receiving each of the first intermediate shares ( [symbol] x′ [symbol] ^{A}) and each of the second intermediate shares ( [symbol] y′ [symbol] ^{A}), the first computer can reveal the first intermediate value (x′) and the second intermediate value (y′) to the other computers of the plurality of computers.

At step 612, after each computer of the plurality of computers receives the first intermediate value (x′) and the second intermediate value (y′), each computer can determine a third intermediate share ( [symbol] z′ [symbol] ^{A}). Each computer can determine the third intermediate share ( [symbol] z′ [symbol] ^{A}) based on the first intermediate value (x′), the second intermediate value (y′), the secret share ( [symbol] x [symbol] ^{A}) of the first value (x), the secret share ( [symbol] y [symbol] ^{A}) of the second value (γ), the secret share ( [symbol] y [symbol] ^{A}) of the fifth value (γ) and the share of the second shared random value ( [symbol] r [symbol] ^{A}). For example, each computer can determine the third intermediate share ( [symbol] z′ [symbol] ^{A}) as follows:

$${〚 {z}^{′} 〛}^{A} := {x}^{′} \cdot {〚 y 〛}^{A} + {y}^{′} \cdot {〚 x 〛}^{A} + {〚 γ 〛}^{A} - {x}^{′} \cdot {y}^{′} + {〚 r 〛}^{A}$$

At step 614, after each computer determines the third intermediate share ( [symbol] z′ [symbol] ^{A}), each computer can send the third intermediate share ( [symbol] z′ [symbol] ^{A}) to the first computer. The first computer can receive each of the third intermediate shares ( [symbol] z′ [symbol] ^{A}) of the third intermediate value (z′) from the network of computers, thus revealing the third intermediate value (z′) in the clear to the first computer. The first computer can reconstruct the third intermediate value (z′) as described in detail herein according to additive secret sharing techniques.

At step 616, after receiving each of the third intermediate shares ( [symbol] z′ [symbol] ^{A}), the first computer can reveal the third intermediate value (z′) to the other computers of the plurality of computers. The first computer can send the third intermediate value (z′) to the other computers in any suitable manner.

At step 618, after each computer of the plurality of computers receives the third intermediate value (z′), each computer can determine an output secret share ( [symbol] ^{A}) based on the third intermediate value (z′), the decimal bit value (d), and the share of the first shared random value ( [symbol] r′ [symbol] ^{A}). For example, each computer can divide the third intermediate value (z′) by the decimal bit value (d) then subtract off the share of the first shared random value ( [symbol] r′ [symbol] ^{A}). In particular, each computer can perform [symbol] ^{A}:=z′/d− [symbol] r′ [symbol] ^{A}.

The output secret share ( [symbol] ^{A}), which is a secret sharing of an output value (z), can be a secret share that, when combined into the output value (z), is equal to the first value (x) multiplied by the second value (y).

TABLE 15
Semi-honest protocol for fixed point multiplication
with additive secret shares.
Π_{AShare-Mul}( [symbol] x [symbol] ^{A}, [symbol] y [symbol] ^{A}, [symbol] α [symbol] ^{A}, [symbol] β [symbol] ^{A}, [symbol] γ [symbol] ^{A}, d)

```
The protocol outputs [symbol]  z [symbol]  ^{A} where z ≈ xy/d.
The security and correctness of the protocol depends on |x|, |y| < 2^{k′} and
|xy| < 2k′ when multiplied over the integers and k ≥ k′ + λ + log₂n.
Preprocessing. For each fixed point multiplication:
  $1. The party {P}_{i} for i ∈ [ t + 1 ] samples {r}_{i} {←}^{\$} {𝕊}_{{2}^{{k}^{′} + λ}} , {generates 〚 {r}_{i} 〛}^{A} ,$ [symbol]
  ^{A}, and sends the shares to the other parties.
  2. All parties locally compute [symbol]  r [symbol]  ^{A}: = Σ_{i∈[t+1]} [symbol]  r′ [symbol]  ^{A}, [symbol] r′ [symbol]  ^{A}: =
    Σ_{i∈[t+1]} [symbol] ^{A}.
Multiply. Upon input shares [symbol]  x [symbol]  ^{A}, [symbol] y [symbol]  ^{A} ∈ [symbol]  ₂_{^{k}}, parties compute
the product as follows:
  1. All parties locally compute [symbol] x′ [symbol]  ^{A}: = [symbol]  x [symbol]  ^{A} + [symbol]  α [symbol]  ^{A} and [symbol]
    y′ [symbol]  ^{A}: = [symbol] y [symbol]  ^{A} + [symbol]  β [symbol]  ^{A} and reveal x′, y′ to P₁.
  2. P₁ sends x′, y′ to all the parties.
  3. All parties locally compute [symbol]  z′ [symbol]  ^{A}: = x′ · [symbol]  y [symbol]  ^{A} + y′ · [symbol]
    x [symbol]  ^{A} + [symbol]  γ [symbol]  ^{A} − x′ · y′ + [symbol]  r [symbol]  ^{A} and reveal z′ to P₁.
  4. P₁ sends z′ to all the parties.
  5. All parties output [symbol]  z [symbol]  ^{A}: = z′/d − [symbol]  r′ [symbol]  ^{A}.
```

The multiplication protocol is multiplication with Beaver triples followed by the new truncation technique. The truncation step does not have to follow a multiplication step and can be used as a general approach whenever truncation is required.

An MPC protocol with additive secret sharing leveraging the fixed point multiplication protocol, according to embodiments, is presented in Table 16. Such a method can be used to compute any arithmetic circuit where multiplications are fixed point multiplication with truncation.

```
TABLE 16
Protocol for MPC with additive secret sharing
Π_{AShare-MPC}
- The protocol works among n parties P₁, ... , Pₙ over an extended ring [symbol]    _{₂}ₖ.
- During the circuit computation, all the intermediate results have absolute value < 2^{k′}.
- k ≥ k′ + λ + log₂n.
Share: Each party Pᵢ shares an input value x ϵ [symbol]    ₂ₖ, by generating [symbol]    ^{A} and sending the shares
  to the other parties.
Linear operations: For any constant c and shares [symbol]    ^{A}, [symbol]    y [symbol]   ^{A}, parties perform linear operations
  on share [symbol]    ^{A} as follows:
  1. Addition by a constant: [symbol]    x + c [symbol]   ^{A} = [symbol]    ^{A} + c (only P₁ adds c on its share)
  2. Addition of shares: [symbol]    x + y [symbol]   ^{A} = [symbol]    ^{A} + [symbol]    y [symbol]   ^{A}
  3. Multiplication by a constant: [symbol]    cx [symbol]   ^{A} = c · [symbol]    ^{A}
Fixed point multiplication: For any two shares [symbol]    ^{A}, [symbol]    y [symbol]   ^{A}, parties perform fixed point
  multiplication as in Table 15.
Reconstruct the output: Each party Pᵢ holds [symbol]    ᵢ^{A} and publicly reconstructs z as follows:
  1. Each party Pᵢ sends its share [symbol]    ᵢ^{A} to P₁.
  2. P₁ recovers z from the shares and sends z to all parties.
```

### VII. PERFORMANCE COMPARISON

The performance of the replicated and Shamir based fixed point multiplication methods according to embodiments will be compared with that of existing work. In particular, embodiments will be compared with [36] for multi-party (semi-honest) replicated secret sharing over [symbol] ₂_{^{k}} and with [16] for Shamir secret sharing over [symbol] _{q} which is widely implemented [9, 31].

TABLE 14
Communication (bits) and round complexity of the method according to
embodiments compared to [16, 36]. For Shamir, embodiments do not include
the cost of generating beaver triples, if applicable.

| Protocol | Operation | Online Rounds | Online Comm | Offline Comm |
|---|---|---|---|---|
| Embodiments, | [symbol] x [symbol] ^{R} · [symbol] y [symbol] ^{R} | 1 or 2 | (n² − nt)k or 2nk | 0 |
| Table 6 | | | | |
| [36] | [symbol] x [symbol] ^{R} · [symbol] y [symbol] ^{R} | 1 | (n² − nt)k | (n² − nt)tk |
| Embodiments, | [symbol] x [symbol] ^{S} · [symbol] y [symbol] ^{S} | 2 | 2nk | (n-t-1)(t+1)k |
| Table 13 | | | | |
| [16] | [symbol] x [symbol] ^{S} · [symbol] y [symbol] ^{S} | 2 | 2nk | 2k²n. |

### A. Replicated Secret Sharing

Mohassel and Zhang [37] study two party secret sharing over [symbol] ₂_{^{k}} and perform stand-alone multiplication and truncation operations in a single round of communication. Methods according to embodiments (if seen in a limiting two-party setting) are similarly performative to theirs.

Mohassel and Rindal [36] generalized to more than two parties by effectively emulating the two party protocol of [37] within another MPC protocol. In essence, the protocol of [36] inputs the shares of the parties into a binary MPC protocol where the underlying value is reconstructed, truncated and then a new arithmetic sharing is generated and output to the parties. Their approach can be optimized to have practical concrete performance. In particular, in the three party case, it involves a pre-processing phase with 2 k binary gates and almost no overhead in the online phase. However, in the multi-party case, when more than 3 parties are involved, it requires ((n²−nt)tk) bits of offline communication and ((n²−nt)k) bits of online communication where t<n/2 is a bound on the number of corrupt parties.

Methods according to embodiments eliminate the need to emulate the two party protocol within a binary protocol. As suggested in Table 14, methods according to embodiments, send approximately t or (n−t)t/2 times less data, depending on how the masked value z′ is revealed. In particular, all the shares of the masked value z′ can either be sent to all (n−t) parties in a set D₁ resulting in a single round protocol or a single party can receive them and then send them to the remaining parties in the set D₁ at the cost of an extra round. Regardless, methods according to embodiments requires significantly less communication than [36], especially in the offline phase where methods according to embodiments are completely non-interactive.

### B. Shamir Secret Sharing

Methods according to embodiments that are utilized for Shamir secret sharing are also a significant improvement over the work of Catrina and Saxena [161. The primary difference is that the protocol of [16] requires preprocessing secret shares of k bits, [symbol] r₁ [symbol] ^{S}, . . . , [symbol] rₖ [symbol] ^{S} which are then used to perform the truncation operation. The typical method [23] for generating a random bit requires sharing a random value and a single multiplication. Therefore, the overall cost of the fixed-point multiplication protocol of [16] is effectively k multiplications.

Methods according to embodiments on the other hand requires (t+1) parties to each generate a random sharing. For an dishonest majority, this can be generated with no interaction using pre-shared keys (e.g., methods according to embodiments would be as efficient as a standard multiplication). More generally, this offline phase requires a total of (n−t−1)(t+1) elements to be sent, along with the overhead of the standard multiplication protocol. This is contrasted with [16] which requires generating k random shares and k multiplications, see Table 14. In practice, embodiments would typically expect n, t«k and so, this represents a significant reduction in communication.

### VIII. FURTHER COMPUTER SYSTEM DETAILS

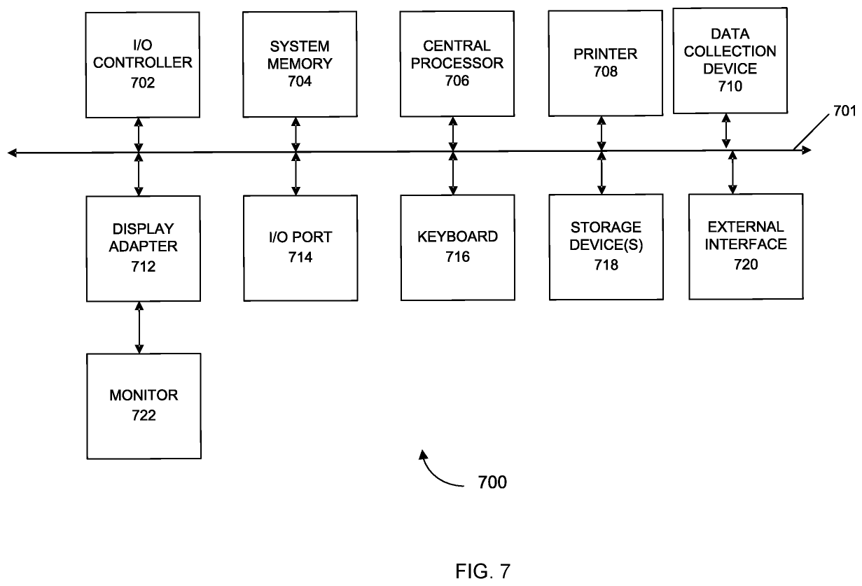

Any of the computer systems mentioned herein may utilize any suitable number of subsystems. Examples of such subsystems are shown in FIG. 7 in computer system 700. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 7 are interconnected via a system bus 701. Additional subsystems such as a printer 708, keyboard 716, storage device(s) 718, monitor 722 (e.g., a display screen, such as an LED), which is coupled to display adapter 712, and others are shown. Peripherals and input/output (I/O) devices, which couple to I/O controller 702, can be connected to the computer system by any number of means known in the art such as input/output (I/O) port 714 (e.g., USB, FireWire©). For example, I/O port 714 or external interface 720 (e.g. Ethernet, Wi-Fi, etc.) can be used to connect computer system 700 to a wide area network such as the Internet, a mouse input device, or a scanner. The interconnection via system bus 701 allows the central processor 706 to communicate with each subsystem and to control the execution of a plurality of instructions from system memory 704 or the storage device(s) 718 (e.g., a fixed disk, such as a hard drive, or optical disk), as well as the exchange of information between subsystems. The system memory 704 and/or the storage device(s) 718 may embody a computer readable medium. Another subsystem is a data collection device 710, such as a camera, microphone, accelerometer, and the like. Any of the data mentioned herein can be output from one component to another component and can be output to the user.

A computer system can include a plurality of the same components or subsystems, e.g., connected together by external interface 720, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

### IX. PROOFS

Security proofs will now be provided for various methods described herein. The proofs are provided to illustrate the improvements provided embodiments as well as the security of the methods and systems. However, it is understood that embodiments are not limited by the following proofs.

### A. Replicated Semi-Honest: Proof

Embodiments now prove that the protocol Π_{RShare-MPC-SH} securely realizes the ideal functionality [symbol] _{C}_{_{d}} against semi-honest adversaries with an honest majority. The rounding error distribution ε is defined by the random variable (Σ_{i∈[m]} sᵢ)/d where sᵢ is uniform over S_{d}. Formally, embodiments prove the following theorem:

Theorem 5.1 Assuming one way functions exist, protocol Π_{RShare-MPC-SH} presented in Table 15 securely computes [symbol] C_{d} (Table 2) with rounding error distribution ε defined above, in the presence of a semi-honest adversary that corrupts a set of t<n/2 parties.

TABLE 15
Protocol for MPC with replicated secret sharing against semi-honest
adversaries.
Π_{RShare-MPC-SH}

```
The protocol works among n parties P₁, . . . , Pₙ over an extended ring
${𝕊}_{{2}^{k}} Let m := ( \begin{matrix}n \\ n - 1\end{matrix} ) and {D}_{1} , … , {D}_{m} ⊂ [ n ] be the m distinct subsets$
of size (n − t). For each j ∈ [m], let Sⱼ be the set of parties indexed by Dⱼ.
  During the circuit computation, all the inputs and outputs of every
  multiplication gate have absolute value < 2^{k′} where k ≥ (k′ + λ +
  log₂(m)).
Setup: Run the setup of protocol Π_{RShare-Mul} in Table 6.
Share: Every party P ∈ {P₁, . . . , Pₙ} shares an input value
x ∈ [symbol]  ₂_{^{k′}} as follows:
  1. Sample x₁, . . . , xₘ ← [symbol]  ₂_{^{k}} such that x = Σ_{i∈[m]} xᵢ.
  2. Send xⱼ to all parties Pᵢ such that i ∈ Dⱼ.
  3. Each party Pᵢ sets [symbol]  x [symbol]  ᵢ^{R}: = {xᵢ | i ∈ Dⱼ}
Linear operations: For any constant c and share [symbol]  y [symbol]  ^{R}, parties perform
  linear operations on share [symbol]  x [symbol]  ^{R} to compute the
  output [symbol]  z [symbol]  ^{R} as follows:
  1. Addition by a constant c: z₁ = x₁ + c and zⱼ = xⱼ for j ∈ [m]/1
  2. Addition of shares: zⱼ = xⱼ + yⱼ for j ∈ [m]
  3. Multiplication by a constant c: zⱼ = cxⱼ for j ∈ [m]
Fixed point multiplication: For any two shares [symbol]  x [symbol]  ^{R}, [symbol]   y [symbol]  ^{R}, parties
  perform fixed point multiplication by running the multiply phase of
  Π_{RShare-Mul} in Table 6.
Output reconstruction: Each party Pᵢ holds [symbol]  z [symbol]  ᵢ^{R} and publicly
  reconstructs z as follows:
  1. For j ∈ [m] where 1 ∉ Dⱼ, P_{min(D}_{ⱼ}₎ sends zⱼ to P₁.
  2. P₁ computes z = Σ_{i∈[m]} zᵢ and sends z to all other parties.
```

Proof. Consider an adversary [symbol] that corrupts a set S* of t parties where t<n/2. Let the honest parties be denoted by set H comprising P_{H}_{₁}, . . . , P_{H}_{_{n−t}}. The simulator [symbol] has as input the following: the output out of the functionality [symbol] _{C}_{_{d}} and the set (inp_{i*}, r_{i*})_{P}_{ᵢ}_{*∈S*} indicating the corrupt parties' inputs and randomness. The strategy of S is described below.

Share: On behalf of each honest party Pᵢ, do:

1. Sample x₁, . . . , xₘ← [symbol] ₂_{^{k}} such that 0=Σ_{i∈[m]} xᵢ.

2. Send xⱼ to [symbol] for each corrupt party P_{i*} where i*∈Dⱼ.

Linear Operations: These are local operations that don't need to be simulated.

Fixed point multiplication: S participates in the setup phase as in Table 6. For each multiplication, for any two shares [symbol] x^{R} [symbol] , [symbol] y^{R} [symbol] , S does:
1. Recall that Sⱼ is the set of parties indexed by Dⱼ. Sample [symbol] r^{R} [symbol] as follows: For each j∈[m], if Sⱼ∩S*=Ø, sample rⱼ← [symbol] ₂_{^{k-log}}₂_{^{(m)}}. Else, set rⱼ:=PRFₛ_{ⱼ}(cnt) as in Table 6.
2. For each honest party Pᵢ, compute βᵢ:=Σ_{j∈[n]/i} γ_{i,j} where γ_{i,j} is computed as follows:
   If Pⱼ∈S*, define γ_{i,j}:= [symbol] ₛ_{_{j,i}} (cnt) for j∈[1, i) and γ_{i,j}:=− [symbol] ₛ_{_{i,j}} (cnt) for j∈(i, n] as in Table 6.
   If Pⱼ∉S*, and j>i, sample γ_{i,j}← [symbol] ₂_{^{k}} and store the value in Γ[i][j]. If Pⱼ∉S*, and j<i, look up Γ and set γ_{i,j}=−Γ[i][j].
3. Run Step 3 to Step 5.

Output reconstruction: S reconstructs output out as follows.

If P₁∉S*:

1. Receive a set of messages from [symbol] .

2. On behalf of P₁, send output out to all other parties.

If P₁∈S*:

1. Set z*=0.

2. From [symbol] 's inputs and randomness (inpᵢ*, rᵢ*)_{P}_{_{i*}}_{∈S}*, and the protocol transcript so far, for each j∈[m], if Sⱼ∩S*≠Ø, compute zⱼ and set z*=z*+zⱼ. If P_{min(D}_{ⱼ}₎∈H, send zⱼ to [symbol] .

3. Let j₁, . . . , [symbol] ∈[m] denote the indices for which Sⱼ∩S*=Ø.

4. Pick zⱼ_{₁} . . . , [symbol] ← [symbol] ₂_{^{k}}. Compute [symbol] ∈ [symbol] ₂_{^{k}} as [symbol] =out− [symbol] −z*.

5. On behalf of the honest parties, send {zⱼ_{₁}, . . . , [symbol] } to [symbol] .

Embodiments show that the above simulation strategy is successful via a hybrid argument.

Hyb₀: Consider a simulator SimHyb that plays the role of the honest parties as in Table 15. This is the real world.

Hyb₁: Switching output. This is similar to Hyb₀ except that SimHyb now runs the output reconstruction step as done by [symbol] in the ideal world by using the output out from the ideal functionality [symbol] _{C}_{_{d}}. Honest parties also get their output from [symbol] _{C}_{_{d}} in this hybrid.

The only difference between Hyb₀ and Hyb₁ is the manner in which parties learn their output. In the real world, correctness of the protocol follows from the invariant that after every linear operation or fixed point multiplication, parties hold a replicated secret sharing of the output. In the case of fixed point multiplication, it is easy to observe that the rounding error associated with the output follows the distribution ε defined above. From the correctness of the protocol, it is easy to observe that the real world output is same as that from the ideal functionality except with negligible error. For the corrupt parties, in Hyb₁, observe that the values {zⱼ_{₁}, . . . , [symbol] } are picked by SimHyb to ensure that the output reconstructed by the corrupt parties is same as the value out from the ideal functionality. Hence, the two hybrids are statistically indistinguishable.

Hyb₂: PRF to random. In this hybrid, for each fixed-point multiplication, on behalf of the honest parties, for each j∈[m], if Sⱼ∩S*=Ø, SimHyb samples rⱼ← [symbol] ₂_{^{k-log}}₂_{^{(m)}} instead of as the output of PRF.

In the multiply phase, for each j∈[m], if Sⱼ∩S*=Ø, in Hyb₁, the honest parties sample the string rⱼ using the pseudorandom function PRF while in Hyb₂, they are sampled uniformly at random. Since the corresponding PRF key sⱼ is not used anywhere else in the protocol, it is easy to observe that if there exists an adversary [symbol] that can distinguish between these two hybrids with non-negligible probability, embodiments can build a reduction [symbol] _{PRF} that breaks the security of the pseudorandom function PRF which is a contradiction. Thus, the two hybrids are computationally indistinguishable.

Hyb₃: PRF to random. In this hybrid, for each fixed-point multiplication, on behalf of each honest party Pᵢ, the 0-share βᵢ is computed as in the ideal world. In particular, the terms γ_{i,j} are sampled randomly from [symbol] ₂_{^{k}} i_{ƒ} Pⱼ∉S* and not as the output of [symbol] .

As in the previous case, the computational indistinguishability between Hyb₂ and Hyb₃ follows from the security of the pseudorandom function [symbol] .

Hyb₄: Switching input. On behalf of each honest party, in the input sharing step, SimHyb now generates shares of 0 instead of the actual input. This hybrid is identical to the ideal world.

First, it is easy to observe that the joint distribution of the honest parties' outputs and [symbol] 's view, at the end of the input sharing phase alone, is identical. This follows from the security of the replicated secret sharing scheme since the adversary corrupts at most t<n/2 parties and so learns at most t shares for each honest party input. The same argument can be extended if embodiments additionally include the linear operations.

It can be argued that in each fixed point multiplication, the adversary's view remains statistically close. In the multiplication protocol, the value z′ is comprised of n values (z′₁, . . . , z′ₙ). For each honest party Pᵢ, the z′ᵢ it generates consists of a term of the product (Σ_{(j,j′)∈A}_{ᵢ}xⱼy_{j′}) masked by a value βᵢ∈ [symbol] ₂_{^{k}}. Observe that, aside from the fact that [symbol] knows Σ_{P}_{ⁱ}_{∈H} βᵢ since they form a sharing of 0, each individual share βᵢ appears uniformly random in [symbol] ₂_{^{k}}. Therefore, it is easy to argue that each value z′ᵢ reveals no information to [symbol] about the product term masked by βᵢ. Then, all parties in D₁ learn z′=x·y+r. Now, r=Σ_{j∈[m]} rⱼ where at least one of the rⱼ values are known only to the honest parties. In particular, for each j such that S*∩Sⱼ=Ø, rⱼ appears uniformly random in the space [symbol] ₂_{^{k′+λ}} to [symbol] . Thus, the product x·y which lies in [symbol] ₂_{^{k′}} is masked by at least one random string that belongs to a larger space [symbol] ₂_{^{k′+λ}}. Thus, it can be argued that [symbol] can distinguish z′=x·y+r between the two hybrids only with probability at most 2^{-λ} and this completes the proof of statistically indistinguishability between the two hybrids.

### B. Replicated Malicious: Proof

In this section, embodiments prove that the protocol Π_{RShare-MPC-Mal} securely realizes the ideal functionality [symbol] _{C}_{_{d}} against semi-honest adversaries with an honest majority. The rounding error distribution ε is defined by the random variable (Σ_{i∈[m]} sᵢ)/d where Sᵢ is uniform over [symbol] _{d}. Formally, embodiments prove the following theorem:

Theorem 3. Assuming one way functions exist, protocol Π_{RShare-MPC-Mal} presented in Table 11 securely computes [symbol] _{C}_{_{d}} (Table 2)) with rounding error distribution ε defined above, in the presence of a malicious adversary that corrupts a set of t<n/2 parties.

Proof Consider an adversary [symbol] that corrupts a set S* of t parties where t<n/2. Let the honest parties be denoted by set H comprising P_{H}_{₁}, . . . , P_{H}_{_{n−t}}. The simulator [symbol] has as input the following: the output out of the functionality [symbol] _{C}_{_{d}} and the set (inpᵢ*,rᵢ*)_{P}_{ᵢ}_{*∈s*} indicating the corrupt parties' inputs and randomness. The strategy of [symbol] is described below.

Setup: Sample α*∈ [symbol] ₂_{^{λ}}. Run the simulator of the MPC protocol where the parties generate α jointly to force α=α* and receive { [symbol] α [symbol] ᵢ^{R}}_{P}_{ᵢ}_{∈H} on behalf of the honest parties. Then, on behalf of each honest party, run the setup of protocol Π_{Rshare-Mul} in Table 6 as in the real world.

Share: On behalf of each honest party P:

1. Sample x₁, . . . , xₘ← [symbol] ₂_{^{k}} such that 0=Σ_{iE[m]} xᵢ. Send xⱼ to [symbol] for each corrupt party P_{i*} where i*∈Dⱼ.

2. Simulate the MPC protocol used to compute functionality [symbol] _{Range} (Table 12).

3. Switch PRF to random: Run the multiplication protocol Π_{Rshare-Mul} (Table 7, Table 8) with the only difference that the PRF values not locally computed by [symbol] are sampled uniformly at random by [symbol] . In more detail,
In Step 1 of Table 7, on behalf of each honest party Pᵢ, compute terms r′ⱼ as follows: If Pⱼ∈S*, define r′_{i,j}:= [symbol] ₛ_{_{j,i}}(cnt) for j∈[1, i) and r′_{i,j}:=− [symbol] ₛ_{_{i,j}}(cnt) for j∈(i, n] as in Table 7. If Pⱼ∉S*, and j>i, sample r′_{i,j}← [symbol] ₂_{^{k}} and store the value in R′[i][j]. If Pⱼ∉S*, and j<i, look up R′[i][j] and set r′_{i,j}=−R′[i][j].
In Step 1 of Table 8, for each j∈(n, m], if Sⱼ∩S*=Ø, sample zⱼ← [symbol] ₂_{^{k}}. Else, set zⱼ:=PRFₛ_{ⱼ}(cnt) as in Table 8.

For each corrupt party P_{i*}'s input sharing:

1. Using the honest parties' shares { [symbol] xᵢ* [symbol] ᵢ^{R}}_{P}_{ⁱ}_{∈H} and the simulator of the MPC protocol for [symbol] _{Range}, extract x_{i*}. If the extraction is unsuccessful, output “Extraction Abort”.

2. Query the ideal functionality [symbol] _{C}_{_{d}} with inputs {x_{i*}}_{P}_{ᵢ}_{*∈S*} and receive output out.

Linear Operations: These are local operations that don't need to be simulated.

Fixed point multiplication: For each multiplication, for any two input shares [symbol] ^{R}, [symbol] ^{R}, [symbol] ^{R}, as in the semi-honest case, the only change is the PRF values not locally computed by [symbol] are now sampled uniformly at random by [symbol] . In more detail, [symbol] does the following:

1. Recall that Sⱼ is the set of parties indexed by Dⱼ. For each j∈[m], if Sⱼ∩S*=Ø, sample rⱼ← [symbol] ₂_{^{k-log}}_{2(m)-λ}. Else, set rⱼ:=PRFₛ_{ⱼ}(cnt) as in Table 9. Compute r′ⱼ=rⱼ/d and run the multiplication protocol (Table 7, Table 11) to compute [symbol] αr [symbol] ^{R}, [symbol] αr′ [symbol] ^{R} with the same changes as listed above in Step 3.

2. For each honest party Pᵢ, compute βᵢ:=Σ_{j∈[n]/i} γ_{i,j} where γ_{i,j} is computed as follows:
If Pⱼ∈S*, define γ_{i,j}: [symbol] ₛ_{_{j,i}}(cnt) for j∈[1, i) and γ_{i,j}:=− [symbol] ₛ_{_{i,j}}(cnt) for j∈(i, n] as in Table 9.
If Pⱼ∉S*, and j>i, sample γ_{i,j}← [symbol] ₂_{^{k}} and store the value in Γ[i][j]. If Pⱼ∉S*, and j<i, look up Γ[i][j] and set γ_{i,j}=−Γ[i][j].

3. Run Step 3 to Step 6 as in Table 9.

4. MAC Check Failure: From the knowledge of all shares of [symbol] α [symbol] ^{R}, [symbol] x [symbol] ^{R}, [symbol] y [symbol] ^{R}, [symbol] r [symbol] ^{R} and the PRF keys, compute the values {z′ᵢ*}_{P}_{_{i*}}_{∈S*} to be sent by the adversary. Output “MAC Abort” if, in Step 5, [symbol] _{MAC.Check} does not abort but the values sent by [symbol] are inconsistent with those calculated above {z′_{i*}}_{P}_{_{i*}}_{∈S*}.

### Output Reconstruction:

1. Set z*=0. For each j∈[m]: note that since Sⱼ\S*≠Ø, i.e., each Sⱼ has at least one honest party, [symbol] knows zⱼ. Update z*=z*+zⱼ if Sⱼ∩S*≠Ø.

2. Let zⱼ_{₁}, . . . , [symbol] ∈[m] denote the indices for which Sⱼ∩S*=0.

3. Pick zⱼ_{₁}, . . . , [symbol] ← [symbol] ₂_{^{k}}. Compute [symbol] ∈ [symbol] ₂_{^{k}} as [symbol] =out− [symbol] −z*.

4. On behalf of the honest parties, send their shares of z as in the real protocol.

5. Receive zⱼ values from [symbol] . As in the real protocol, if [symbol] sent inconsistent values to any honest party Pᵢ, instruct the ideal functionality [symbol] _{C}_{_{d}} to deliver output “Abort” to that honest party. Else, instruct Fc_{d} to deliver the correct output out.

Embodiments now show that the above simulation strategy is successful via a hybrid argument.

Hyb₀: Consider a simulator SimHyb that plays the role of the honest parties as in Table 11. This is the real world.

Hyb₁: Random α. In the setup phase, sample α*∈ [symbol] ₂_{^{λ}}. Run the simulator of the MPC protocol where the parties generate α jointly to force α=α*.

Indistinguishability of Hyb₀ and Hyb₁ is implied by the security of the MPC protocol used to jointly generate α.

Hyb₂: Input extraction. In the input sharing phase, SimHyb runs step Step 1 as done in the ideal world. That is, using the honest parties' shares { [symbol] x_{i*} [symbol] ᵢ^{R}}_{P}_{ᵢ}_{∈H} and the simulator of the MPC protocol for [symbol] _{Range}, extract {x_{i*}}_{*∈S}* and query [symbol] _{C}_{_{d}} to learn output out. If the extraction is unsuccessful, output “Extraction Abort”.

From the security of the MPC protocol for [symbol] _{Range}, the probability that the Simulator of MPC protocol for [symbol] _{Range} aborts without successfully extracting the inputs but in the real execution, the honest parties don't abort is negligible. As a result, the probability that SimHyb outputs “Extraction Abort” in Hyb₂ is negligible. Apart from that, notice that the distributions produced by both Hyb₁ and Hyb₂ are the same. Hence, the two hybrids are indistinguishable.

Hyb₃: Switching output. SimHyb now runs the output reconstruction step as done by [symbol] in the ideal world by using the output out received from [symbol] _{C}_{_{d}}.

Honest parties also get their output from [symbol] _{C}_{_{d}} in this hybrid.

The only difference between Hyb₂ and Hyb₃ is the manner in which parties learn their output. For the corrupt parties, in Hyb₃, observe that the values {zⱼ_{₁}, . . . , [symbol] } are picked by SimHyb to ensure that the output reconstructed by the corrupt parties is same as the value out from the ideal functionality. In the real world, correctness of the protocol is easy to observe (as in the semi-honest case). Finally, observe that as in the real world, if SimHyb detects any inconsistent shares sent by [symbol] to any honest party, it instructs [symbol] _{C}_{_{d}} to deliver output “Abort” to that honest party. Thus, as in the semi-honest case, it is easy to observe that the real world output is same as that from the ideal functionality except with negligible error. Hence, the two hybrids are statistically indistinguishable.

Hyb₄: PRF to random. In the multiplication protocols, all the pseudorandom function outputs not locally computed by [symbol] are now sampled uniformly at random as done by [symbol] in the ideal world.

As in the semi-honest protocol, it is easy to see that the computational indistinguishability between Hyb₃ and Hyb₄ follows from the security of the pseudorandom functions PRF and [symbol] .

Hyb₅: MAC Check. SimHyb runs Step 4 as in the ideal world and outputs “MAC Abort” if [symbol] successfully sends incorrect shares of z′ while making sure [symbol] _{MAC.Check} succeeds.

Since the MAC key α appears uniformly random to [symbol] , the security of [symbol] _{MAC.Check} guarantees that the probability that [symbol] _{MAC.Check} succeeds while q successfully sends incorrect shares of z′ is negligible. As a result, the probability that SimHyb outputs “MAC Abort” in Hyb₄ is negligible and the two hybrids are indistinguishable.

Hyb₆: Simulate [symbol] _{Range}. In the input sharing step, simulate the MPC protocol used to compute functionality [symbol] _{Range}.

Indistinguishability of Hyb₆ and Hyb₇ follows from the security of the MPC protocol used to compute [symbol] _{Range}.

Hyb₇: Switching input. On behalf of each honest party, in the input sharing step, SimHyb now generates shares of 0 instead of the actual input. This hybrid is identical to the ideal world.

The argument is similar to that in the semi-honest protocol. The only difference here is that, unlike the semi-honest protocol, [symbol] does not necessarily follow the protocol honestly. However, the below two things guarantee that any deviation from honest behavior by [symbol] will be detected by the honest parties with overwhelming probability without revealing anything about the input. (i) In the fixed point multiplication protocol, the MAC check (functionality [symbol] _{MAC.Check}) guarantees that every share of z′ is correctly generated by [symbol] . (ii) Apart from the shares of z′ computed in the fixed point multiplication, for any other value [symbol] ^{R} computed as part of the circuit evaluation, every share of [symbol] ^{R} is held by at least one honest party—this is because t<n/2 and so (n−t)>t. Thus, the two hybrids are statistically indistinguishable and this completes the proof.

### C. Shamir: Proof

In this section, embodiments prove that the protocol Π_{SShare-MPC} securely realizes the ideal functionality [symbol] _{C}_{_{d}} against semi-honest adversaries corrupting t<n/2 parties. The rounding error distribution ε is defined by the random variable (Σ_{i∈[t+1}] sᵢ)/d where sᵢ is uniform over [symbol] _{d}. Formally, embodiments prove the following theorem:

Theorem 7.1 The protocol Π_{SShare-MPC} presented in Table 14 statistically securely realizes the functionality [symbol] _{C}_{_{d}} (defined in Table 2) with rounding error distribution ε in the presence of a semi-honest adversary that corrupts t<n/2 parties.

Proof Correctness of the protocol follows from the invariant that after every linear operation or fixed point multiplication, parties hold t-out-of-n Shamir secret sharing of the output. This is straightforward for linear operations. In terms of fixed point multiplication by truncation, the invariant relies on the fact that (Σ_{i∈[t+1]} rᵢ)/d≈Σ_{iE[t+1]} rᵢ/d. Note that each |rᵢ|<2^{k′+λ}, hence Σ_{i∈[t+1}] |rᵢ|<2^{k+λ}. (t+1), which suggests that Σ_{i∈[t+1]} rᵢ does not overflow. Therefore (Σ_{i∈[t+1]} rᵢ)/d≈Σ_{i∈[t+1]} rᵢ/d, where the rounding error follows the distribution ε defined above.

For security, consider an adversary [symbol] that corrupts a set C of t parties, denoted as P_{C}_{₁}, . . . , P_{C}_{ₜ}. Let the honest parties be denoted by set H comprising P_{H}_{₁}, . . . , P_{H}_{_{n−t}}. The simulator [symbol] has as input the following: the output out of the functionality [symbol] _{C}_{_{d}} and the set {(inp_{C}_{ᵢ}, r_{C}_{ᵢ})}_{i∈[t]} indicating the corrupt parties' inputs and randomness. Embodiments construct a PPT simulator [symbol] that follows the protocol description of the corrupted parties to generate [symbol] 's view and does the following on behalf of honest parties:

Share: On behalf of each honest party P_{H}_{ᵢ}:

1. Sample s₁, . . . ,

$${s}_{t} {←}^{\$} {𝔽}_{d} .$$

2. Send sⱼ to [symbol] for each corrupt party P_{C}_{ⱼ}.

Linear operations: These are local operations that don't need to be simulated.

Fixed point multiplication: For each fixed point multiplication:
Preprocessing:

1. For each corrupt party P_{C}_{ᵢ} where Cᵢ∈[t+1], sample

$${r}_{{C}_{i}} {←}^{\$} {𝕊}_{{2}^{{k}^{′} + λ}} .$$

2. For each honest party P_{H}_{ᵢ} where Hᵢ∈[t+1], sample

$${r}_{{H}_{i}} {←}^{\$} {𝕊}_{{2}^{{k}^{′} + λ}} ,$$

generate [symbol] r_{H}_{ᵢ} [symbol] ^{S,2t}, [symbol] r_{H}_{ᵢ}/d [symbol] ^{S}, and send the shares to the corrupted parties.

3. Let r:=Σ_{i∈[t+1]} rᵢ.
Online multiplication:
If P₁ is an honest party, let z′: r and send it to [symbol] on behalf of P₁.
If P₁ is a corrupt party, compute the shares of [symbol] z′ [symbol] ^{S,2t} for all the corrupt parties. Let the shares of the honest parties be random such that the reconstructed z′=r, and send them to P₁ on behalf of the honest parties.

### Reconstruct the Output:

If P₁ is an honest party, then let [symbol] :=out and send it to [symbol] on behalf of P₁.
If P₁ is a corrupt party, compute the shares of [symbol] ^{S} for all the corrupt parties. Let the shares of the honest parties be random such that the reconstructed [symbol] =out, and send these shares to P₁ on behalf of the honest parties.

Embodiments now show that the above simulation strategy is successful via a hybrid argument.

Hyb₀: [symbol] 's view and the honest parties' output in the real world.

Hyb₁: Same as Hyb₀ except that in the final step to reconstruct the output, the simulator does the following on behalf of the honest parties: if P₁ is an honest party, then let z:=out from the ideal functionality and send it to [symbol] on behalf of P₁; otherwise, let the shares of the honest parties be random such that the reconstructed z=out, and send these shares to P₁ on behalf of the honest parties. In the meanwhile, replace the honest parties' output in the real world by their output in the ideal world.

Hyb₀ and Hyb₁ are statistically identical, which follows from the correctness of the protocol. Since there is at least one share held by honest parties, it is statistically identical to [symbol] if the honest parties sample their shares to be consistent with the output.

Hyb₂: Same as Hyb₁ but for each fixed point multiplication by truncation, the simulator manipulates the honest parties' shares to be random such that z′=x·y+r.

This hybrid is statistically identical to Hyb₁ because there is at least one rᵢ contributed by honest parties in preprocessing. It is thus statistically identical to [symbol] if the honest parties randomly sample their shares to be consistent with z′.

Hyb₃: Same as Hyb₂ but for each fixed point multiplication by truncation, the simulator manipulates the honest parties' shares to be random such that z′=r instead of x·y+r.

Since x·y∈ [symbol] ₂_{^{k′}}, and there is at least one rᵢ (sampled from [symbol] ₂_{^{k′+λ}}) contributed by honest parties in preprocessing, the distribution of r and x·y+r are statistically close. Hence this hybrid is statistically indistinguishable from Hyb₂.

Hyb₄: Same as Hyb₃ except that on behalf of each honest party P_{H}_{ᵢ}, the simulator sends random shares to the corrupt parties for its input.

This hybrid is statistically identical to Hyb₃, which follows from the security of Shamir secret sharing. This hybrid outputs the simulated view along with the honest parties' output in the ideal world, which concludes the proof.

### D. Additive: Proof

In this section, embodiments prove that the protocol Π_{AShare-MPC} securely realizes the ideal functionality [symbol] _{C}_{_{d}} against semi-honest adversaries corrupting t<n parties. The rounding error distribution ε is defined by the random variable (Σ_{i∈[t+1]} sᵢ)/d where sᵢ is uniform over [symbol] _{d}. Formally, embodiments prove the following theorem:

Theorem 12.1 Given preprocessed Beaver triples, the protocol Π_{AShare-MPC} presented in Table 16 statistically securely realizes the functionality [symbol] _{C}_{_{d}} (defined in Table 2) with rounding error distribution ε in the presence of a semi-honest adversary that corrupts t<n parties.

Proof Correctness of the protocol follows from the invariant that after every linear operation or fixed point multiplication, parties hold an additive sharing of the output. This is straightforward for linear operations. For fixed point multiplication by truncation, the method according to embodiments can include multiplication with Beaver triples followed by a truncation using [symbol] r [symbol] ^{A} and [symbol] r′ [symbol] ^{A}. The invariant relies on the fact that (Σ_{i∈[t+1]} rᵢ)d≈Σ_{i∈[t+1]} rᵢ/d. Note that each |rᵢ|<2^{k′+λ}, hence Σ_{i∈[t+1]} |rᵢ|2^{k′+λ}·(t+1), which suggests that Σ_{i∈[t+1]} rᵢ does not overflow. Therefore (Σ_{i∈[t+1}] rᵢ)/d≈Σ_{i∈[t+1]} rᵢ/d, where the rounding error follows the distribution ε defined above.

For security, consider an adversary [symbol] that corrupts a set C of t parties, denoted as P_{C}_{₁}, . . . , P_{C}_{ₜ}. Let the honest parties be denoted by set H comprising P_{H}_{₁}, . . . , P_{H}_{_{n−t}}. The simulator [symbol] has as input the following: the output out of the functionality [symbol] _{C}_{_{d}} and the set {(inp_{C}_{ᵢ}, r_{C}_{ᵢ})}_{i∈[t]} indicating the corrupt parties' inputs and randomness. Embodiments construct a PPT simulator [symbol] that follows the protocol description of the corrupted parties to generate [symbol] 's view and does the following on behalf of honest parties:

Share: On behalf of each honest party P_{H}_{ᵢ}:

1. Sample s₁, . . . ,

$${s}_{t} {←}^{\$} {𝕊}_{{2}^{k}} .$$

2. Send sⱼ to [symbol] for each corrupt party P_{C}_{ⱼ}.

Linear operations: These are local operations that don't need to be simulated.

Fixed point multiplication: For each fixed point multiplication with truncation:
Preprocessing:

1. For each corrupt party P_{C}_{ᵢ} where Cᵢ∈[t+1], sample

$${r}_{{C}_{i}} {←}^{\$} {𝕊}_{{2}^{k ′ + λ}} .$$

2. On behalf of each honest party P_{H}_{ᵢ} where Hᵢ∈[t+1], sample

$${r}_{{H}_{i}} {←}^{\$} {𝕊}_{{2}^{k ′ + λ}} ,$$

generate [symbol] r_{H}_{ᵢ} [symbol] ^{A}/ [symbol] r_{H}_{ᵢ}/d [symbol] ^{A}, and send the shares to the corrupted parties.

3. Let r:=Σ_{i∈[t+1]} rᵢ.

### Online Multiplication:

If P₁ is an honest party, then sample x′,

$${y}^{′} {←}^{\$} {𝕊}_{{2}^{k}}$$

and let z′:=r; send x′, y′, z′ to [symbol] on behalf of P₁.

If P₁ is a corrupt party, then let the shares of [symbol] ^{A} and [symbol] y′ [symbol] ^{A} of the honest parties be random and send them to P₁ on behalf of them. Next, compute the shares of [symbol] z′ [symbol] ^{A} for all the corrupt parties. Let the shares of the honest parties be random such that the reconstructed z′=r, and send these shares to P₁ on behalf of the honest parties.

### Reconstruct the Output:

If P₁ is an honest party, then let z:=out and send it to [symbol] on behalf of P₁.

If P₁ is a corrupt party, then compute the shares of [symbol] z [symbol] ^{A} for all the corrupt parties. Let the shares of the honest parties be random such that the reconstructed z=out, and send these shares to P₁ on behalf of the honest parties.

Embodiments now show that the above simulated view together with the honest parties' output in the ideal world is statistically indistinguishable from [symbol] 's view and the honest parties' output in the real world via a hybrid argument.

Hyb₀: [symbol] 's view and the honest parties' output in the real world.

Hyb₁: Same as Hyb₀ except that in the final step to reconstruct the output, the simulator does the following on behalf of the honest parties: if P₁ is an honest party, then let z:=out from the ideal functionality and send it to [symbol] on behalf of P₁; otherwise, let the shares of the honest parties be random such that the reconstructed z=out, and send these shares to P₁ on behalf of the honest parties. In the meanwhile, replace the honest parties' output in the real world by their output in the ideal world.

Hyb₀ and Hyb₁ are statistically identical, which follows from the correctness of the protocol. Since there is at least one share held by honest parties, it is statistically identical to [symbol] if the honest parties sample their shares to be consistent with the output.

Hyb₂:Same as Hyb₁ but for each fixed point multiplication by truncation, the simulator manipulates the honest parties' shares to be random such that z′=x·y+r.

This hybrid is statistically identical to Hyb₁ because there is at least one rᵢ contributed by honest parties in preprocessing. It is thus statistically identical to A if the honest parties randomly sample their shares to be consistent with z′.

Hyb₃:Same as Hyb₂ but for each fixed point multiplication by truncation, the simulator manipulates the honest parties' shares to be random such that z′=r instead of x·y+r.

Since x·y·∈ [symbol] ₂_{^{k′}}, and there is at least one rᵢ (sampled from [symbol] ₂_{^{k′+λ}}) contributed by honest parties in preprocessing, the distribution of r and x·y+r are statistically close. Hence this hybrid is statistically indistinguishable from Hyb₂.

Hyb₄: Same as Hyb₂ but for fixed point multiplication by truncation, the simulator manipulates the honest parties' shares of x′ and y′ to be random.

First, x′=x+α is uniformly random in [symbol] ₂_{^{k}} as

$$α {←}^{\$} {𝕊}_{{2}^{k}} .$$

Since there is at least one share of α held by honest parties, the distribution of x′ is statistically identical if the honest parties sample their shares randomly. For the same reason, the distribution of y′ is statistically identical if the honest parties sample their shares randomly. Hence this hybrid is statistically identical from Hyb₃.

Hyb₅: Same as Hyb₄ except that on behalf of each honest party P_{H}_{ᵢ}, the simulator sends random shares to the corrupt parties for its input.

This hybrid is statistically identical to Hyb₄, which follows from the security of addictive secret sharing. This hybrid outputs the simulated view along with the honest parties' output in the ideal world, which concludes the proof.

### X. REFERENCES

1. Google cloud ai. cloud.google.com/products/machine-learning/.
2. Machine learning on aws. aws.amazon.com/machine-learning/.
3. Microsoft azure. azure.microsoft.com/en-us/services/machine-learning-studio/.
4. Watson machine learning. ibm.com/cloud/machine-learning.
5. Martin Abadi, Andy Chu, Ian J. Goodfellow, H. Brendan McMahan, Ilya Mironov, Kunal Talwar, and Li Zhang. Deep learning with differential privacy. In CCS, 2016.
6. Mark Abspoel, Daniel Escudero, and Nikolaj Volgushev. Secure training of decision trees with continuous attributes. PETS, 2021.
7. Joy Algesheimer, Jan Camenisch, and Victor Shoup. Efficient computation modulo a shared secret with application to the generation of shared safe-prime products. In CRYPTO, 2002.
8. Mehrdad Aliasgari, Marina Blanton, Yihua Zhang, and Aaron Steele. Secure com¬putation on floating point numbers. In NDSS, 2013.
9. Abdelrahaman Aly, Marcel Keller, Emmanuela Orsini, Dragos Rotaru, Peter Scholl, Nigel P Smart, and Tim Wood. Scale-mamba v1. 2: Documentation, 2018.
10. Assi Barak, Martin Hirt, Lior Koskas, and Yehuda Lindell. An end-to-end system for large scale P2P mpc-as-a-service and low-bandwidth MPC for weak participants. In CCS, 2018.
11. Megha Byali, Harsh Chaudhari, Arpita Patra, and Ajith Suresh. FLASH: fast and robust framework for privacy-preserving machine learning. PETs, 2020.
12. Octavian Catrina. Round-efficient protocols for secure multiparty fixed-point arithmetic. In COMM, 2018.
13. Octavian Catrina. Towards practical secure computation with floating-point numbers. Balkan CryptSec, 2018.
14. Octavian Catrina. Efficient secure floating-point arithmetic using shamir secret sharing. In ICETE, 2019.
15. Octavian Catrina. Optimizing secure floating-point arithmetic: Sums, dot products, and polynomials. 2020.
16. Octavian Catrina and Amitabh Saxena. Secure computation with fixed-point numbers. In Financial Cryptography, 2010.
17. Harsh Chaudhari, Ashish Choudhury, Arpita Patra, and Ajith Suresh. ASTRA: high throughput 3pc over rings with application to secure prediction. In CCSW, 2019.
18. Harsh Chaudhari, Rahul Rachuri, and Ajith Suresh. Trident: Efficient 4pc framework for privacy preserving machine learning. In NDSS, 2020.
19. Koji Chida, Daniel Genkin, Koki Hamada, Dai Ikarashi, Ryo Kikuchi, Yehuda Lin¬dell, and Ariel Nof. Fast large-scale honest-majority mpc for malicious adversaries. In CRYPTO, 2018.
20. Anders P. K. Dalskov, Daniel Escudero, and Marcel Keller. Secure evaluation of quantized neural networks. PETS, 2020.
21. Anders P. K. Dalskov, Daniel Escudero, and Marcel Keller. Fantastic four: Honest-majority four-party secure computation with malicious security. IACR ePrint, 2020.
22. Ivan Damgird, Daniel Escudero, Tore Kasper Frederiksen, Marcel Keller, Peter Scholl, and Nikolaj Volgushev. New primitives for actively-secure MPC over rings with applications to private machine learning. In IEEE S&P, 2019.
23. Ivan Damgird, Marcel Keller, Enrique Larraia, Valerio Pastro, Peter Scholl, and Nigel P.
Smart. Practical covertly secure MPC for dishonest majority—or: Breaking the SPDZ limits. In ESORICS, 2013.
24. Vassil Dimitrov, Liisi Kerik, Toomas Krips, Jaak Randmets, and Jan Willemson. Alternative implementations of secure real numbers. In CCS, 2016.
25. Daniel Escudero and Anders P. K. Dalskov. Honest majority MPC with abort with minimal online communication. IACR ePrint, 2020.
26. Daniel Escudero, Satrajit Ghosh, Marcel Keller, Rahul Rachuri, and Peter Scholl. Improved primitives for MPC over mixed arithmetic-binary circuits. In CRYPTO, 2020.
27. Oded Goldreich. The Foundations of Cryptography. 2004.
28. Oded Goldreich, Silvio Micali, and Avi Wigderson. How to play any mental game or A completeness theorem for protocols with honest majority. In STOC, 1987.
29. Vipul Goyal, Yifan Song, and Chenzhi Zhu. Guaranteed output delivery comes free in honest majority mpc. In CRYPTO, 2020.
30. Chiraag Juvekar, Vinod Vaikuntanathan, and Anantha Chandrakasan. GAZELLE: A low latency framework for secure neural network inference. In USENIX Security, 2018.
31. Marcel Keller. MP-SPDZ: A versatile framework for multi-party computation. In CCS, 2020.
32. Nishat Koti, Mahak Pancholi, Arpita Patra, and Ajith Suresh. SWIFT: super-fast and robust privacy-preserving machine learning. IACR ePrint, 2020.
33. Toomas Krips and Jan Willemson. Hybrid model of fixed and floating point num¬bers in secure multiparty computations. In International Conference on Information Security, 2014.
34. Nishant Kumar, Mayank Rathee, Nishanth Chandran, Divya Gupta, Aseem Ras-togi, and Rahul Sharma. Cryptflow: Secure tensorflow inference. In IEEE S&P, 2020.
35. Pratyush Mishra, Ryan Lehmkuhl, Akshayaram Srinivasan, Wenting Zheng, and Raluca Ada Popa. Delphi: A cryptographic inference service for neural networks. In USENIX Security, 2020.
36. Payman Mohassel and Peter Rindal. Aby3: A mixed protocol framework for ma¬chine learning. In CCS, 2018.
37. Payman Mohassel and Yupeng Zhang. Secureml: A system for scalable privacy-preserving machine learning. In IEEE S&P, 2017.
38. Arpita Patra, Thomas Schneider, Ajith Suresh, and Hossein Yalame. ABY2.0: improved mixed-protocol secure two-party computation. In USENIX Security, 2020.
39. Arpita Patra and Ajith Suresh. BLAZE: blazing fast privacy-preserving machine learning. In NDSS, 2020.
40. Pille Pullonen and Sander Siim. Combining secret sharing and garbled circuits for efficient private ieee 754 floating-point computations. In Michael Brenner, Nicolas Christin, Benjamin Johnson, and Kurt Rohloff, editors, Financial Cryptography, 2015.
41. Deevashwer Rathee, Mayank Rathee, Nishant Kumar, Nishanth Chandran, Divya Gupta, Aseem Rastogi, and Rahul Sharma. Cryptflow2: Practical 2-party secure inference. In CCS, 2020.
42. Tord Reistad and Tomas Toft. Linear, constant-rounds bit-decomposition. In ICISC, 2009.
43. Adi Shamir. How to share a secret. Commun. ACM, 1979.
44. Sameer Wagh, Divya Gupta, and Nishanth Chandran. Securenn: 3-party secure computation for neural network training. PETs, 2019.

Aspects of embodiments can be implemented in the form of control logic using hardware circuitry (e.g. an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The specific details of particular embodiments may be combined in any suitable manner without departing from the spirit and scope of embodiments of the disclosure. However, other embodiments of the disclosure may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art. Where a conflict exists between the instant application and a reference provided herein, the instant application shall dominate.

1. A method performed by a first computer of a plurality of computers for implementing a replication protocol for multi-party fixed point multiplication, the method comprising:
obtaining a first secret share of a first secret value (x) and a second secret share of a second secret value (y);
jointly sampling a first pseudo-random key (s_{i,j}) with another computer paired with the first computer and a second pseudo-random key (sⱼ) with a first set (Dⱼ) of multiple sets in the plurality of computers;
generating a replicated random share of a random value ( [symbol] r [symbol] ^{R}) using the second pseudo-random key (sⱼ);
generating a replicated sharing value (β) using the first pseudo-random key (s_{i,j});
computing a masked share (z′ᵢ₌₁) by providing a product of the first secret share and the second secret share masked with the replicated sharing value (β) and the replicated random shares of the random value ( [symbol] r [symbol] ^{R});
receiving, by the first computer from computers in the first set (Dⱼ), a plurality of masked shares (z′ᵢ), thereby revealing a set shared value z′ to the first set (Dⱼ); and
generating a replicated secret share ( [symbol] z [symbol] ^{R}) using the received plurality of masked shares (z′ᵢ) and the replicated random shares of the random value ( [symbol] r [symbol] ^{R}).

2. The method of claim 1, wherein generating the one or more replicated random shares of the random values ( [symbol] r [symbol] ^{R}) using the second pseudo-random key (sⱼ) further includes adding a MAC key (α) to the one or more replicated random shares of the value, wherein the MAC key (α) is randomly sampled.

3. The method of claim 2, wherein the masked share (z′ᵢ₌₁) includes the MAC key (α).

4. The method of claim 3, wherein the method further comprises:
executing a batch check consistency protocol to determine whether each computer in the plurality of computers generated the replicated secret share ( [symbol] z [symbol] ^{R}) from the masked share (z′ᵢ₌₁) that included the MAC key (α).

5. The method of claim 1, wherein the replicated sharing value (β) from each of the computers of the plurality of computers sum to zero.

6. The method of claim 1, wherein after receiving the plurality of masked shares (z′ᵢ) from the plurality of computers in the first set (Dⱼ) the method further comprises:
obtaining the set shared value (z′) from the plurality of masked shares and the masked share (z′ᵢ), wherein the plurality of masked shares and the masked share (z′ᵢ) are an n-out-of-n secret sharing of the set shared value (z′).

7. The method of claim 1, wherein computers of the plurality of computers in a second set of the multiple sets determine a respective value for the replicated secret share ( [symbol] z [symbol] ^{R}) using respective random shares of the random value ( [symbol] r [symbol] ^{R}).

8. The method of claim 1 further comprising:
obtaining a decimal bit value (d).

9. The method of claim 8, wherein generating the replicated secret share ( [symbol] z [symbol] ^{R}) further comprises:
generating, by the first computer, a first replicated secret share (z₁) of the replicated secret share ( [symbol] z [symbol] ^{R}) by dividing the set shared value (z′) by the decimal bit value (d) and then subtracting the replicated random share of a value ( [symbol] r [symbol] ^{R}) divided by the decimal bit value (d).

10. A method performed by a first computer of a plurality of computers for implementing a sharing protocol for multi-party fixed point multiplication, the method comprising:
obtaining a secret share of a first value (x), a secret share of a second value (γ);
sampling a first random value (rᵢ) to obtain a first random share ( [symbol] rᵢ [symbol] ^{S,2t}) of the first random value (rᵢ) and a second random share ( [symbol] rᵢ [symbol] ^{S,2t});
sending the first random share ( [symbol] rᵢ [symbol] ^{S,2t}) and the second random share ( [symbol] rᵢ/d [symbol] ^{S}) to the plurality of computers;
obtaining each share of the first random share ( [symbol] r [symbol] ^{S,2t}) and each share of the second random share ( [symbol] rᵢ/d [symbol] ^{S}) from the plurality of computers;
computing a third random share ( [symbol] r [symbol] ^{S,2t}) and a fourth random share ( [symbol] r [symbol] ^{S}) based on each share of the first random share ( [symbol] z′ [symbol] ^{S,2t}) and each share of the second random share ( [symbol] rᵢ [symbol] ^{S,2t}), respectively;
computing a masked share ( [symbol] z′ [symbol] ^{S,2t}) that provides a product of the secret share of the first value (x) and the secret share of the second value (y) masked with the third random share ( [symbol] rᵢ [symbol] ^{S,2t});
obtaining a masked value (z′) based on a plurality of masked shares ( [symbol] z′ [symbol] ^{S,2t}) determined by the plurality of computers; and
generating an output secret share ( [symbol] z [symbol] ^{S}) using the masked value (z′) and the fourth random share ( [symbol] r′ [symbol] ^{S}).

11. The method of claim 10, wherein the second random share ( [symbol] rᵢ/d [symbol] ^{S}) is equal to the first random share ( [symbol] rᵢ [symbol] ^{S}) divided by a decimal bit value (d).

12. The method of claim 10, wherein the output secret share ( [symbol] z [symbol] ^{S}) represents a shared output value (z) that is approximately equal to the first value (x) multiplied by the second value (y) divided by a decimal bit value (d).

13. The method of claim 10, wherein obtaining the masked value (z′) further comprises:
obtaining, by the first computer, a plurality of masked shares ( [symbol] z′ [symbol] ^{S,2t}) from the plurality of computers;
generating the masked value (z′) based on the plurality of masked shares ( [symbol] z′ [symbol] ^{S,2t}); and
providing the masked value (z′) to the plurality of computers.

14. The method of claim 10, wherein generating the output secret share ( [symbol] z [symbol] ^{S}), further comprises:
generating the output secret share ( [symbol] z [symbol] ^{S}) by dividing the masked value (z′) by a decimal bit value (d) and subtracting off the fourth random share (r′^{S}).

15. The method of claim 10, wherein the first random share ( [symbol] rᵢ [symbol] ^{S,2t}) is determined using 2t-out-of-n sharing.

16. A method performed by a first computer of a plurality of computers for implementing an additive sharing protocol for multi-party fixed point multiplication, the method comprising:
obtaining a secret share ( [symbol] ^{A}) of a first value (x), a secret share ( [symbol] y [symbol] ^{A}) of a second value (y), a decimal bit value (d), a secret share ( [symbol] α [symbol] ^{A}) of a third value (α), a secret share ( [symbol] β [symbol] ^{A}) of a fourth value (β), and a secret share ( [symbol] γ [symbol] ^{A}) of a fifth value (γ);
determining a share of a first shared random value ( [symbol] r′ [symbol] ^{A}) and a share of a second shared random value ( [symbol] r [symbol] ^{A});
determining a first intermediate share ( [symbol] ^{A}) based on the secret share ( [symbol] ^{A}) of the first value (x) and the secret share ( [symbol] α [symbol] ^{A}) of the third value (α);
determining a second intermediate share ( [symbol] y′ [symbol] ^{A}) based on the secret share ( [symbol] y [symbol] ^{A}) of the second value (y) and the secret share ( [symbol] β [symbol] ^{A}) of the fourth value (β);
receiving, by the first computer, a plurality of first intermediate shares and a plurality of second intermediate shares from the plurality of computers to reveal a first intermediate value (x′) and a second intermediate value (y′);
sending, by the first computer, the first intermediate value (x′) and the second intermediate value (y′) to the plurality of computers;
determining a third intermediate share ( [symbol] z′ [symbol] ^{A}) based on the first intermediate value (x′), the second intermediate value (y′), the secret share ( [symbol] ^{A}) of the first value (x), the secret share ( [symbol] y [symbol] ^{A}) of the second value (y), the secret share ( [symbol] y [symbol] ^{A}) of the fifth value (γ) and the share of the second shared random value ( [symbol] r [symbol] ^{A});
receiving, by the first computer, a plurality of third intermediate shares from the plurality of computers to reveal a third intermediate value (z′);
sending, by the first computer, the third intermediate value (z′) to the plurality of computers; and
determining an output secret share ( [symbol] ^{A}) based on the third intermediate value (z′), the decimal bit value (d), and the share of the first shared random value ( [symbol] r′ [symbol] ^{A}).

17. The method of claim 16, wherein the secret share of the third value (α), the secret share of the fourth value (β), and the secret share of the fifth value (γ) make up a preprocessed Beaver triple, and wherein the first value (x) and the second value (y) are fixed point values represented in twos-complement form in a ring ( [symbol] ₂_{^{k′}}).

18. The method of claim 16, and wherein determining the share of the first shared random value ( [symbol] r′ [symbol] ^{A}) and the share of the second shared random value ( [symbol] r [symbol] ^{A}) further comprises:
sampling an extended ring ( [symbol] ₂_{^{k′+λ}}) to generate shares of a first initial random value ( [symbol] ^{A}) and shares of a second initial random value ( [symbol] ^{A}), where the shares of the second initial random value ( [symbol] ^{A}) are created based on the shares of the first initial random value ( [symbol] ^{A}) and the decimal bit value (d);
sending the shares of the first initial random value ( [symbol] ^{A}) and the shares of the second initial random value ( [symbol] ^{A}) to the plurality of computers;
determining shares of the first shared random value ( [symbol] r′ [symbol] ^{A}) based on the shares of the second initial random value ( [symbol] ^{A}); and
determining a share of the second shared random value ( [symbol] r [symbol] ^{A}) based on the shares of the first shared random value ( [symbol] r′ [symbol] ^{A}).

19. The method of claim 16, wherein the output secret share ( [symbol] ^{A}) is a share of an additive output value (z) that is approximately equal to the first value (x) multiplied by the second value (y) divided by the decimal bit value (d).

20. The method of claim 16, wherein the first value (x) and the second value (y) are fixed point vales represented in twos-complement form.

21. (canceled)
